(19) United States
(12) Patent Application Publication
(10) Pub. No.: US 2021/0130626 A1
(43) Pub. Date: May 6, 2021

(54) POLYMER COATING COMPOSITIONS

(71) Applicant: THE BOEING COMPANY, Chicago, IL (US)

(72) Inventors: Weidong YANG, Clayton (AU); Ranya SIMONS, Melbourne (AU); Sheng LI, Melbourne (AU); Xiaoqing ZHANG, Clayton (AU); Jill E. SEEBERGH, Seattle, WA (US); Douglas H. BERRY, Seattle, WA (US)

(21) Appl. No.: 17/041,860

(22) PCT Filed: Mar. 26, 2019
(86) PCT No.: PCT/AU2019/050265

§ 371 Date: Sep. 25, 2020

Related U.S. Application Data
(60) Provisional application No. 62/648,023, filed on Mar. 26, 2018.

(51) Int. Cl. C09D 5/20; C09D 175/04; C09D 7/61; C08K 3/22; C08K 3/24; C08K 3/38; C08K 5/05; B05D 3/10; B05D 3/12; B05D 7/00

(52) U.S. Cl. CPC C09D 5/20; C09D 175/04; C09D 7/61; C08K 3/22; C08K 3/24; C08K 3/38; C09D 123/0869; B05D 3/107; B05D 3/12; B05D 7/582; B05D 7/586; C08K 2003/2296; C08K 2003/387; C08K 5/05

(57) ABSTRACT

The present disclosure generally relates to adhesion promoting intercoating layers, selectively strippable coatings, coating compositions, and methods of making and using the compositions and coatings. A coating composition can be provided comprising an organic polymer containing acid functionalities, a metallic agent, and a boron agent, which may be used on a coated substrate as a selectively strippable and/or adhesion promoting intercoating layer. The coating compositions can be applied to coated substrates within a broad application window and used within multi layered coating systems.

### FIELD

The present disclosure generally relates to adhesion promoting intercoating layers, selectively strippable coatings, coating compositions, and methods of making and use thereof.

### BACKGROUND

Stripping of paints and other coatings along with subsequent repainting of vehicles is a routine practice in industries such as the aerospace industry. In this process, layers of paint are stripped from the vehicle, either chemically and/or mechanically. The use of an intercoating layer applied between a coated substrate and any one or more post coating or topcoat layers on the coated substrate, can provide a method for facilitating ‘selective’ and efficient stripping of the post-coating or topcoat layers while preserving the integrity of the underlying coatings and substrate. The intercoating layer can act to provide a weak link during chemical paint stripping to enable a mechanism for selectively removing the topcoat without having to remove the entire coating system, but also forms a strong bond between topcoat and coated substrate to allow adequate adhesion for in-service use. The use of an intercoating layer as a selectively strippable coating can reduce the time required to complete the re-coating process and to further protect the underlying materials or layers from an abrasive or other stripping medium.

Apart from enabling selective removal of topcoat or other coating layers, the intercoating layer should also meet the application and in-service performance requirements desired by the particular use or application. In terms of aerospace coating systems, this may include meeting various desired standards for chemical resistance, environmental durability, mechanical properties, aesthetics, and adhesion.

There is a need for alternative or improved intercoating layers and selectively strippable coatings that can provide various desirable properties such as a broad application, cure and stripping window, effective adhesion and in-service performance, and/or properties enabling effective process control during application and curing.

### SUMMARY

The present disclosure relates to a coating composition comprising an organic polymer containing acid functionalities, a metallic agent, and a boron agent. The coating compositions can provide a selectively strippable intercoating layer or coating, an adhesion promoting intercoating layer, or a combination thereof. The selectively strippable coating compositions can be used on a coated substrate, for example a previously coated substrate. The selectively strippable coating composition can be applied to a coated substrate within a broad application window (e.g. time, temperature and humidity) with post coating layers then applied thereon to form a multi layered coating system providing an effective adhesion and in-service use, for example in the automotive or aerospace industry. The selectively strippable intercoating layer enables selective removal of the post coating layers from the coated substrate for servicing or application of a replacement coating system to the coated substrate.

In one aspect, there is provided a coating applied to a coated substrate, the coating comprising:

a) one or more organic polymers comprising carboxylic acid functionalities;

b) a metallic agent; and

c) a boron agent.

In another aspect, there is provided a coating applied to a coated substrate, wherein the coating consists of:

(a) one or more organic polymers comprising carboxylic acid functionalities;

(b) a metallic agent;

(c) a boron agent;

(d) optionally a solvent;

(e) optionally an inorganic filler;

(f) optionally a wetting agent;

(g) optionally an organic crosslinker; and

(h) optionally an additive(s).

In another aspect, there is provided a coating applied to a coated substrate, the coating comprising:

a) an organic film former comprising one or more organic polymers comprising carboxylic acid functionalities;

b) a metallic agent; and

c) a boron agent.

In one example, the organic film former comprises or consists of at least one polymeric constituent selected from an organic polymer comprising carboxylic acid functionalities and a resin. The one or more organic polymers comprising carboxylic acid functionalities or resin may have a number average molecular weight of at least 5000, 7500, 10000, 12500, or 15000. In another example, the organic film former comprises or consists of an organic polymer comprising carboxylic acid functionalities. The one or more organic polymers comprising carboxylic acid functionalities may have a number average molecular weight of at least about 5000 or between about 5000 and 100000. The one or more organic polymers comprising carboxylic acid functionalities of (a) may be provided by an organic film former comprising or consisting of one or more organic polymers comprising carboxylic acid functionalities. The carboxylic acid functionalities of each organic polymer may be provided in an amount of between about 2 to 30 wt % of the organic polymer or between about 10 to 20 wt % of the organic polymer.

The metallic agent (b) and boron agent (c) may be provided by a metal-boron complex or salt. The molar ratio (M:A) of the metallic agent (M) to the acid functionality (A) of the organic polymer may be provided between about 10:1 (M:A) to 1:10 (M:A) or between about 2:1 (M:A) to 1:2 (M:A). The molar ratio (M:B) of metallic agent (M) to boron agent (B) may be provided between about 10:1 (M:B) to 1:10 (M:B) or between about 2:1 (M:B) to 1:2 (M:B).

The coating can be an adhesion promoting intercoating layer, selectively strippable intercoating layer, or a combination thereof. In one example, the coating is a selectively strippable intercoating layer. The substrate of the coated substrate may be a composite, metal, polymer or elastomer substrate material. For example, the coated substrate may be a primer coated composite or conversion coated metal.

It is understood that the metallic agent and boron agent in the selectively strippable coating can provide a coordination complex with the carboxylic acid functionalities of the organic polymer in the selectively strippable coating, and with functionalities of the coated substrate and/or post coating layers. This can provide an effective adhesion of the selectively strippable coating to a coated substrate, and to any post coating layers, for achieving a desired in-service use while still enabling selective removal at a later post curing stage.

The one or more organic polymers comprising carboxylic acid functionalities may be selected from the group consisting of polyurethane, polyamide, polyether, polyester, polyolefin, co-polymers thereof, and blends thereof. It will be appreciated that each of these polymers contain carboxylic acid functionalities, for example prepared or modified to contain carboxylic acid functionalities by using particular comonomers or by grafting on acid functionalities. In one example, at least one organic polymer comprising carboxylic acid functionalities is selected from a polyurethane and a polyolefin. The polyolefin may be a polyethylene, for example a polyethylene co-acrylic acid copolymer. In another example, at least one organic polymers comprising carboxylic acid functionalities is selected from a polyurethane and polyethylene, each being a co-carboxylic acid copolymer thereof. In another example, the one or more organic polymers comprising carboxylic acid functionalities comprise or consist of a polyurethane co-carboxylic acid copolymer. In another example, the one or more organic polymers comprising carboxylic acid functionalities comprise or consist of a polyethylene co-acrylic acid copolymer (PEAA). In another example, the PEAA may be provided in an amount of about 0.1% to about 25% by weight based on weight of the one or more organic polymers.

The boron agent may be a boron compound selected from one or more of boron hydride, boron hydroxide, boron oxide, ammonium salt thereof, and metal borate thereof. The boron agent may be an acidic boron agent, such as an agent capable of providing a Lewis acid and Bronsted acid. The boron agent may be a metallic agent comprising boron according to any examples as described herein. The boron agent can be dissolvable in an ammonia solution, which can facilitate formation of a co-complex structure with the metallic agent according to examples as described herein. In some examples, the boron agent is selected from one or more of a diborane, boric acid, boronic acid, ammonium borate, and zinc borate.

The metallic agent may comprise a metal that is selected a transition metal. It will be appreciated that the transition metal may be selected from Groups 3 to 12 of the Periodic table. For example, the metallic agent may comprise a non-alkaline metal, which would exclude the metallic agent from containing any alkali metals such as sodium or alkaline earth metals such as calcium. The metallic agent may comprise one or more metals, wherein the one or more metals consist of a transition metal. The metallic agent may comprise a metal selected from the group consisting of zinc, copper, nickel, zirconium, titanium, vanadium, tungsten, and any combinations thereof. The metallic agent may be in the form of a metal complex or salt, such as a metal oxide or salt thereof. For example, the metal may be zinc or an oxide or salt thereof. The metal salt may be an amine metal hydroxide, such as tetraamine zinc hydroxide. In one example, the metallic agent is zinc oxide (ZnO). In another example, the boron agent is boric acid. In another example, the metallic agent is zinc oxide and the boron agent is boric acid (BA). The metallic agent may further comprise boron. The metallic agent may comprise boron and one or more metals, wherein the one or more metals consist of a transition metal as described herein.

The metallic agent and boron agent can be derived from the same compound or agent, for example a metal-boron complex or salt. The metallic agent and boron agent in the above selectively strippable coating may be provided by a reaction product of the metallic agent and boron agent according to any examples of those individual agents as described herein. In other words, the components b) and c) of the above coating may be a boron-metal complex or salt. The metal-boron complex or salt may be a metal borate, such as a zinc borate. The metal-boron complex can be in the form an oxide, for example a complex comprising or consisting of boron, zinc and oxygen atoms. The metal may be selected from at least one of zinc, copper, nickel, zirconium, titanium, vanadium, and tungsten. For example, the metal may be zinc or an oxide thereof. In one example, the metallic agent is ZnO and boron agent is boric acid (BA). In other words, the metal-boron complex is ZnO:BA. In one example, the metallic agent and the boron agent are provided by zinc borate, such as Zinc borate Firebrake® ZB (2ZnO.3B₂O₃.3.5H₂O), Zinc borate Firebrake® 500 (2ZnO.3B₂O₃), Zinc borate Firebrake® 415 (4ZnO.B₂O₃.H₂O), ZB-467 (4ZnO.6B₂O₃.7H₂O), ZB-223 (2ZnO.2B₂O₃.3H₂O).

In one example, there is provided a selectively strippable coating applied to a coated substrate, the selectively strippable coating comprising:

a) one or more organic polymers comprising carboxylic acid functionalities;

b) a metal-boron complex or salt.

In another example, there is provided a selectively strippable coating applied to a coated substrate, the selectively strippable coating comprising:

a) an organic film former comprising one or more organic polymers comprising carboxylic acid functionalities;

b) a metal-boron complex or salt.

The coating may further comprise a wetting agent, which may be provided in an amount of about 0.01% to about 15% w/v.

In another example, there is provided a selectively strippable coating applied to a coated substrate, wherein the selectively strippable coating consists of (a) one or more organic polymers comprising carboxylic acid functionalities, (b) a metallic agent, (c) a boron agent, (d) solvent, (e) optionally an inorganic filler, (f) optionally a wetting agent, (g) optionally an organic crosslinker, and (h) optionally an additive(s).

In another example, there is provided a selectively strippable coating applied to a coated substrate, wherein the selectively strippable coating consists of (a) one or more organic polymers comprising carboxylic acid functionalities, (b) a metal-boron complex or salt, (d) solvent, (e) optionally an inorganic filler, (f) optionally a wetting agent, (g) optionally an organic crosslinker, and (h) optionally an additive(s).

The component (a) may be provided by an organic film former according to any examples as described herein. Each of the individual components (a) to (h) may be independently provided in the composition according to any examples or embodiments as described herein.

In another aspect, there is provided a coating system which comprises:
(i) a coated substrate;
(ii) at least one post coating layer; and
(iii) the selectively strippable coating according to any aspects, embodiments or examples as described herein, located between (i) and (ii).

The coated substrate may be provided as described herein according to any other aspects, embodiments or examples thereof.

In another aspect, there is provided a selectively strippable coating composition comprising:

a) an organic polymer comprising carboxylic acid functionalities;

b) a metallic agent; and

c) a boron agent.

Any of the features a), b), and c), for the above composition may be provided as described herein according to any other aspects, embodiments or examples thereof.

In another aspect, there is provided a selectively strippable coating composition comprising:

a) an organic film former comprising one or more organic polymers comprising carboxylic acid functionalities;

b) a metallic agent; and

c) a boron agent.

Any of the features a), b), and c), for the above composition may be provided as described herein according to any other aspects, embodiments or examples thereof.

In one example, the selectively strippable coating composition comprises:

a) an organic polymer comprising carboxylic acid functionalities;

b) a metallic agent;

c) a boron agent; and

d) a solvent.

In another example, the selectively strippable coating composition comprises:

a) an organic film former comprising one or more organic polymers comprising carboxylic acid functionalities;

b) a metallic agent;

c) a boron agent; and

d) a solvent.

The selectively strippable coating composition may be a water based coating formulation, for example the solvent may be an aqueous solvent system. The composition may further comprise an alcohol, for example in an amount of about 1% to about 60% wt. based on the total composition.

The one or more organic polymers comprising carboxylic acid functionalities, metallic agent, boron agent, or metal-boron complex or salt thereof, may each be provided in the composition according to any example thereof as described above for the coating or as described otherwise herein.

In one example, the selectively strippable coating composition comprises:

a) an organic polymer comprising carboxylic acid functionalities; and

b) a metal-boron complex or salt.

In another example, the selectively strippable coating composition comprises:

a) an organic film former comprising one or more organic polymers comprising carboxylic acid functionalities; and

b) a metal-boron complex or salt.

The organic polymer or metal-boron complex or salt for the above composition may be provided as described herein according to any other aspects, embodiments or examples thereof.

In another example, the selectively strippable coating composition comprises:

a) an organic polymer comprising carboxylic acid functionalities;

b) a metal-boron complex or salt; and

c) a solvent.

In another example, the selectively strippable coating composition comprises:

a) an organic film former comprising one or more organic polymers comprising carboxylic acid functionalities;

b) a metal-boron complex or salt; and

c) a solvent.

As mentioned, the metal-boron complex or salt may be provided by any example as described herein, such as a metal borate, for example a zinc borate.

The coating composition may further comprise a wetting agent, for example in an amount of about 0.01% to about 15% w/v. The wetting agent may be propylene glycol ethers.

In another example, the coating composition further comprises or further consists of at least one of an organic crosslinker, inorganic filler, wetting agent and additive(s). In another embodiment or example, the selectively strippable coating composition comprises or consists of (a) one or more organic polymers comprising carboxylic acid functionalities, (b) a metallic agent, (c) a boron agent, (d) solvent, (e) optionally an inorganic filler, (f) optionally a wetting agent, (g) optionally an organic crosslinker, and (h) optionally an additive(s). In another embodiment or example, the selectively strippable coating composition comprises or consists of (a) one or more organic polymers comprising carboxylic acid functionalities, (b) a metal-boron complex or salt, (d) solvent, (e) optionally an inorganic filler, (f) optionally a wetting agent, (g) optionally an organic crosslinker, and (h) optionally an additive(s). The component (a) may be provided by an organic film former according to any examples as described herein. Each of the individual components (a) to (h) are described in further detail below, and may be independently provided in the composition according to any examples or embodiments as described herein. As mentioned, the composition may be a formulation, such as a liquid formulation, for which the following examples and embodiments may apply.

In another aspect, there is provided a selectively strippable coating being a reaction product of the selectively strippable coating composition according to any aspect, embodiment or example as described herein.

In another aspect, there is provided a process for preparing a coating system according to any aspects, embodiments or examples as described herein comprising:

applying the selectively strippable coating composition to the coated substrate; and

applying at least one post coating layer to the selectively strippable coating present on the coated substrate.

The coated substrate may be provided as described herein according any other aspects, embodiments or examples thereof. For example, the coated substrate can be a conversion coated metal, a conversion coated metal alloy, or a coated composite material. The substrate of the coated substrate can be a support structure, panel, or section, of a building, vehicle or aircraft. The coated substrate can be an aircraft or a section or panel of an aircraft.

The process may comprise applying the selectively strippable coating composition to the coated substrate within a first predetermined time, temperature and humidity; and applying at least one post coating layer to the selectively strippable coating present on the coated substrate within a second predetermined time, temperature and humidity. For the first and second predetermined humidity and temperature, the relative humidity in the process environment is between about 10% and 85% and the temperature range is between about 15° C. and 35° C. The process can be performed in a large area capable of servicing larger aircraft sections or entire aircraft.

In another aspect, there is provided a process for selectively removing at least one post coating layer from the coating system according to any aspects, embodiments or examples as described herein comprising:

a) treating the at least one post coating layer with an alkaline stripping agent capable of disrupting the selectively strippable coating; and

b) removing the at least one post coating layer from the coated substrate.

The alkaline stripping agent can be provided as an aqueous alkaline liquid formulation comprising the alkaline stripping agent, one or more solvents, and one or more optional additives.

The process may further comprise:

a) treating the post coating layer(s) with an alkaline stripping agent capable of disrupting the selectively strippable coating;

b) removing the post coating layer(s) from the coated substrate and optionally applying a mechanical process for facilitating the removal of the post coating layer(s);

c) optionally cleaning the surface of the substrate;

d) optionally applying a selectively strippable coating composition and any post-coating layers according to any aspects, embodiments or examples as described herein.

Any embodiment herein shall be taken to apply mutatis mutandis to any other embodiment unless specifically stated otherwise.

The present disclosure is not to be limited in scope by the specific embodiments described herein, which are intended for the purpose of exemplification only. Functionally-equivalent products, compositions and methods are clearly within the scope of the disclosure, as described herein.

Throughout this specification, unless specifically stated otherwise or the context requires otherwise, reference to a single step, composition of matter, group of steps or group of compositions of matter shall be taken to encompass one and a plurality (i.e. one or more) of those steps, compositions of matter, groups of steps or groups of compositions of matter.

### BRIEF DESCRIPTION OF THE DRAWINGS

Preferred embodiments of the present disclosure will be further described and illustrated, by way of example only, with reference to the accompanying drawings in which:

FIG. 1 shows non-limiting examples of a boron agent, metallic agent, and metal-boron complex as crosslinking moieties, in the selectively strippable coatings described herein, according to some embodiments of the present disclosure.

FIG. 2 shows a diagrammatic scale of 1-10 representing visual amount of % removal of a coating present on a coated substrate by rain erosion testing.

FIGS. 3a and 3b show schematic representations of a general process for preparing a coating system, and for removal of the selectively strippable coating for application of a fresh coating system, respectively, according to some embodiments of the present disclosure.

### DETAILED DESCRIPTION

The present disclosure describes the following various non-limiting examples, which relate to investigations undertaken to identify alternative and improved coating compositions and coatings. The coatings and compositions thereof of the present disclosure can provide a selectively strippable intercoating layer, an adhesion promoting intercoating layer, or a combination thereof. It was surprisingly found that a coating composition comprising an organic polymer containing carboxylic acid functionalities, a metallic agent, and a boron agent, can be used to prepare a selectively strippable coating on a coated substrate with effective adhesion under a broad application window, which is also selectively strippable under a broad stripping application (removal) window. The coating compositions and coatings as described herein have been found suitable for various uses, and in particular use in the aerospace industry.

### General Definitions and Terms

Unless specifically defined otherwise, all technical and scientific terms used herein shall be taken to have the same meaning as commonly understood by one of ordinary skill in the art (e.g., in polymers, coatings, chemistry and the like).

The term “and/or”, e.g., “X and/or Y” is be understood to mean either “X and Y” or “X or Y” and provides explicit support for both meanings or for either meaning.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

“Alkyl” whether used alone, or in compound words such as alkylaryl, represents straight or branched chain hydrocarbons ranging in size from one to about 20 carbon atoms, or more. Thus alkyl moieties include, unless explicitly limited to smaller groups, moieties ranging in size, for example, from one to about 6 carbon atoms or greater, such as, methyl, ethyl, n-propyl, iso-propyl and/or butyl, pentyl, hexyl, and higher isomers, including, e.g., those straight or branched chain hydrocarbons ranging in size from about 6 to about 20 carbon atoms, or greater.

The term “carboxylic acid functionality” as used herein refers to any chemical moiety that is capable of functioning as a carboxylic acid or can form a carboxylic acid group in situ.

### Coating Compositions

The coating compositions of the present disclosure can be adhered to coated substrates, and following adhesion and in-service use then be selectively removed (including any post-coating layers on the strippable coating) from the coated substrates by using an appropriate stripping formulation while at the same time preserving the integrity of the underlying coated substrate. In this way the coating compositions can provide an adhesive promoting and/or strippable intercoating (IC) layer for use in a coating system on a coated substrate. At least according to some embodiments and examples, the coating compositions and coatings as described herein can provide a broad application window for initially curing and adhering the coatings to the coated substrates and a broad stripping application window for removal/stripping of the coatings from the coated substrates. The coating compositions as described herein can be used in providing a selectively strippable coating.

The selectively strippable coating composition can comprise a) an organic polymer comprising carboxylic acid functionalities, b) a metallic agent, and c) a boron agent, each of which may be independently provided by any embodiments or examples as described herein. In one embodiment or example, there is provided a selectively strippable coating composition comprising:

a) an organic polymer comprising carboxylic acid functionalities;

b) a metallic agent;

c) a boron agent; and

d) a solvent.

The selectively strippable coating composition can comprise a) an organic film former comprising one or more organic polymers comprising carboxylic acid functionalities, b) a metallic agent, and c) a boron agent, each of which may be independently provided by any embodiments or examples as described herein. In one embodiment or example, there is provided a selectively strippable coating composition comprising:

a) an organic film former comprising one or more organic polymers comprising carboxylic acid functionalities;

b) a metallic agent;

c) a boron agent; and

d) a solvent.

It will be appreciated that the “organic film former” encompasses any polymeric constituents that could be provided in the composition or coating thereof. The polymeric constituents consist of any polymers (e.g. copolymers) or polymerizable components, such as reactive monomers (e.g. resins) that can form polymers in the coatings. The polymeric constituents may consist of polymers, copolymers, resins, monomers and comonomers. The organic film former does not encompass any organic crosslinker, inorganic filler, wetting agent and additive(s), which are described further below. For example, if any monomers, co-monomers, resins, copolymers, and polymers, are present in the composition, formulation or coating thereof, then it is understood those prospective constituents are encompassed by the term “organic film former”. In examples where the organic film former “consists of” one or more specified constituents, then it will be appreciated that the absence of a prospective polymeric constituent being explicitly specified in the organic film former means the absence of that polymeric constituent from the composition, formulation or coating thereof. In other words, when the term “consists of” is used then only those polymeric constituents specified to consist in the organic film former are present in the composition, formulation or coating thereof.

In one example, the organic film former comprises or consists of at least one organic polymer comprising carboxylic acid functionalities. In another example, the organic film former consists of at least one polymeric constituent being an organic polymer comprising carboxylic acid functionalities, and optionally at least one polymeric constituent selected from polymers, copolymers, resins, comonomers, and monomers. In another example, the organic film former consists of at least one polymeric constituent being an organic polymer comprising carboxylic acid functionalities, and optionally at least one polymeric constituent devoid of acid functionalities selected from polymers, copolymers, resins, comonomers, and monomers. In another example, the organic film former consists of at least one polymeric constituent being an organic polymer comprising carboxylic acid functionalities, and optionally at least one other polymeric constituent having a number average molecular weight of at least about 5000. In another example, the organic film former consists of at least one polymeric constituent being an organic polymer comprising carboxylic acid functionalities, and optionally a resin devoid of acid functionalities or having a number average molecular weight of at least about 5000. The organic polymer comprising carboxylic acid functionalities in the organic film former may be provided according to any one or more examples or embodiments as described herein.

In other examples, each of the polymeric constituents of the organic film former have a number average molecular weight of at least about 5000, 7500, 10000, 12500, 15000, 17500, 20000, 25000, or 50000. In other examples, each of the polymeric constituents of the organic film former have a number average molecular weight of less than about 500000, 400000, 300000, 200000, 100000, 75000, or 50000. In other examples, each of the polymeric constituents of the organic film former have a number average molecular weight provided by any two of the above upper and/or lower values, for example in a range of about 5,000 to 100,000, 7500 to 200000, or 10000 to 100000.

It will be appreciated that the above compositions can be provided as formulations (e.g. liquid formulation), which are described further below. It is understood that the metallic agent and boron agent in the selectively strippable coating can provide a coordination complex with the carboxylic acid functionalities of the organic polymer in the selectively strippable coating, and functionalities of the coated substrate and/or post coating layers. This can provide an effective adhesion of the selectively strippable coating to a coated substrate, and to any post coating layers, for achieving a desired in-service use while still enabling selective removal at a later post curing stage.

In one example, the organic polymers comprising carboxylic acid functionalities are organic polymers comprising carboxylic acid or carboxylate groups. The one or more organic polymers comprising carboxylic acid functionalities may be selected from the group consisting of polyurethane, polyamide, polyether, polyester, polyolefin, co-polymers thereof, and blends thereof. It will be appreciated that each of these polymers contain carboxylic acid functionalities, for example prepared or modified to contain carboxylic acid functionalities by using particular comonomers or by grafting on acid functionalities. In one example, the one or more organic polymers comprising carboxylic acid functionalities are selected from at least one of a polyurethane, such as one or more polyurethanes comprising carboxylic acid functionalities. In one example, the one or more organic polymers comprising carboxylic acid functionalities are selected from at least one of a polyurethane and a polyolefin. The polyolefin may be a polyethylene, for example a polyethylene co-acrylic acid copolymer. In another example, the one or more organic polymers comprising carboxylic acid functionalities are selected from at least one of a polyurethane and polyethylene, each being a co-carboxylic acid copolymer thereof. In another example, the one or more organic polymers comprising carboxylic acid functionalities comprise or consist of a polyurethane co-carboxylic copolymer. In another example, the one or more organic polymers comprising carboxylic acid functionalities comprise or consist of a polyethylene co-acrylic acid copolymer (PEAA).

In another example, the carboxylic acid functionalities in each organic polymer, such as carboxylic acids in polyurethane and/or PEAA, may be provided in an amount of about 0.1 to about 25 wt % of the total organic polymer. The carboxylic acid functionalities may be provided in the organic polymer, such as carboxylic acid groups in polyurethane and/or PEAA, in an amount (wt % of carboxylic acid functionalities/groups in the organic polymer) of at least about 1, 2, 3, 4, 5, 6, 7, 8, 9, 10, 11, 12, 13, 14, 15, 16, 17, 18, 19, or 20. The carboxylic acid functionalities may be provided in the organic polymer, such as carboxylic acid groups in polyurethane and/or PEAA, in an amount (wt % of acid functionalities/groups in the organic polymer) of less than about 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, or 2. The carboxylic acid functionalities may be provided in the organic polymer in an amount between any two of these upper and/or lower values, such as between 1 and 20, 5 and 30, or 10 and 25.

In one example, the carboxylic acid containing organic polymer, namely the one or more organic polymers comprising carboxylic acid functionalities, is a polyurethane comprising carboxylic acid functionalities. The carboxylic acid functionalities may be provided according to any one of the above examples for the carboxylic acid containing organic polymer. Further interlayer adhesion and compatibility can be provided by such a polyurethane polymer as described herein. For example, the carboxylic acid functionalities may be provided in the polyurethane in an amount (wt % of carboxylic acid functionalities/groups in the polyurethane polymer) of at least about 1, 2, 3, 4, 5, 6, 7, 8, 9, 10, 11, 12, 13, 14, 15, 16, 17, 18, 19, or 20. The carboxylic acid functionalities may be provided in the polyurethane polymer in an amount (wt % of acid functionalities/groups in the organic polymer) of less than about 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, or 2. The carboxylic acid functionalities may be provided in the polyurethane polymer in an amount between any two of these upper and/or lower values, such as between about 1 and 20, 5 and 30, or 10 and 25. In one particular example, the carboxylic acid functionalities may be provided in the polyurethane in an amount (wt % of acid functionalities/groups in the polyurethane polymer) between about 3 to 25.

The boron agent may be a boron compound selected from one or more of boron hydride, boron hydroxide, boron oxide, ammonium salt thereof, and metal borate thereof. The boron agent may be an acidic boron agent, such as an agent capable of providing a Lewis acid and Bronsted acid. The boron agent may be a metallic agent comprising boron according to any examples as described herein. The boron agent can be dissolvable in an ammonia solution, which can facilitate formation of a co-complex structure with the metallic agent according to examples as described herein. In some examples, the boron agent is selected from one or more of a diborane, boric acid, boronic acid, ammonium borate, and zinc borate.

The metallic agent may comprise a metal that is selected a transition metal. It will be appreciated that the transition metal may be selected from Groups 3 to 12 of the Periodic table. For example, the metallic agent may comprise a non-alkaline metal, which would exclude the metallic agent from containing any alkali metals such as sodium or alkaline earth metals such as calcium. The metallic agent may comprise one or more metals, wherein the one or more metals consist of a transition metal. The metallic agent may comprise a metal selected from the group consisting of zinc, copper, nickel, zirconium, titanium, vanadium, tungsten, and any combinations thereof. The metallic agent may be in the form of a metal complex or salt, such as a metal oxide or salt thereof. For example, the metal may be zinc or an oxide or salt thereof. The metal salt may be an amine metal hydroxide, such as tetraamine zinc hydroxide. In one example, the metallic agent is zinc oxide (ZnO). In another example, the boron agent is boric acid. In another example, the metallic agent is zinc oxide and the boron agent is boric acid (BA). The metallic agent may further comprise boron. The metallic agent may comprise boron and one or more metals, wherein the one or more metals consist of a transition metal as described herein.

The metallic agent and boron agent can be derived from the same compound or agent, for example a metal-boron complex or salt. The metallic agent and boron agent may be provided by a reaction product of the metallic agent and boron agent according to any examples of those individual agents as described herein. In other words, the components b) and c) of the above composition may be a boron-metal complex or salt. The metal-boron complex or salt may be a metal borate, such as a zinc borate. The metal-boron complex can be in the form an oxide, for example a complex comprising or consisting of boron, zinc and oxygen atoms. The metal may be selected from at least one of zinc, copper, nickel, zirconium, titanium, vanadium, and tungsten. For example, the metal may be zinc or an oxide thereof. In one example, the metallic agent is ZnO and boron agent is boric acid (BA). In other words, the metal-boron complex is ZnO:BA. In one example, the metallic agent and the boron agent are provided by zinc borate, such as Zinc borate Firebrake® ZB (2ZnO.3B₂O₃.3.5H₂O), Zinc borate Firebrake® 500 (2ZnO.3B₂O₃), Zinc borate Firebrake® 415 (4ZnO.B₂O₃.H₂O), ZB-467 (4ZnO.6B₂O₃. 7H₂O), ZB-223 (2ZnO.2B₂O₃.3H₂O).

In an example, the selectively strippable coating composition comprises a) an organic polymer comprising carboxylic acid functionalities and b) a metal-boron complex, each of which may be independently provided by any embodiments or examples as described herein. In an example, the selectively strippable coating composition comprises: a) an organic polymer comprising carboxylic acid functionalities; and b) a metal-boron complex. In another example, the selectively strippable coating composition comprises: a) an organic polymer comprising carboxylic acid functionalities; b) a metal-boron complex; and c) a solvent.

In some embodiments or examples, the selectively strippable coating composition further comprises or further consists of at least one of an organic crosslinker, inorganic filler, wetting agent and additive(s). In another embodiment or example, the selectively strippable coating composition comprises or consists of (a) one or more organic polymers comprising carboxylic acid functionalities, (b) a metallic agent, (c) a boron agent, (d) solvent, (e) optionally an inorganic filler, (f) optionally a wetting agent, (g) optionally an organic crosslinker, and (h) optionally an additive(s). In another embodiment or example, the selectively strippable coating composition comprises or consists of (a) one or more organic polymers comprising carboxylic acid functionalities, (b) a metal-boron complex or salt, (d) solvent, (e) optionally an inorganic filler, (f) optionally a wetting agent, (g) optionally an organic crosslinker, and (h) optionally an additive(s). The component (a) may be provided by an organic film former according to any examples as described herein. Each of the individual components (a) to (h) are described in further detail below, and may be independently provided in the composition according to any examples or embodiments as described herein. As mentioned, the composition may be a formulation, such as a liquid formulation, for which the following examples and embodiments may apply.

In one example, the composition has a low solid concentration of about 1% to 40% based on the total weight of the composition, for example about 1 to 25%, 2 to 15%, or about 3% to 10%. The composition may have a low solid concentration (in % based on the total weight of the composition) of less than about 40, 35, 30, 25, 20, 15, 10, 9, 8, 7, 6, or 5. The composition may have a solid concentration (in % based on the total weight of the composition) of at least about 1, 2, 3, 4, 5, 6, 7, 8, 9, 10, 15, 20, 25, or 30. The solid concentration may be provided in a range between any two of these upper and/or lower values. The low solids content can facilitate application of the organometallic layer on the substrate and avoid thick film build up. The coating dispersion of the composition can be formulated at low solids content so thin coatings from sub-micrometers to a few micrometers can be achieved on a commercial scale.

The coating composition can be provided as a coating formulation for commercial and industrial application. A coating formulation can be prepared by dissolving or dispersing the coating compositions comprising the one or more organic polymers, metallic agent, boron agent, or metal-boron complex or salt, in an appropriate solvent and then mixing them together optionally with one or more additives or dissolving the compositions into a suitable solvent under suitable processing conditions. The coating formulation can be prepared from a multi-part composition which can be pre dissolved in suitable solvents, and which can then be pre-mixed together prior to application of the coating composition to the coated substrate. In an alternative embodiment, the coating composition can be formulated into a one-part stable dispersion, which for example would not require premixing before application. For example, the composition as described herein may be a liquid formulation, such as liquid suspension formulation or liquid dispersion formulation.

The coating composition may be applied in different physical forms such as a solution, dispersion, suspension, mixture, aerosol, emulsion, paste or combination thereof, solutions or dispersions or emulsions are preferred.

The coating composition may be provided as a water-based formulation, for example as a dispersion comprising the one or more organic polymers, metallic agent, boron agent, or metal-boron complex or salt. Water-based formulations typically contain lower amounts of organic solvents. In one example, the estimated theoretical volatile organic content (VOC) of the coating formulation is between about 80 and 700 gm/1 depending on the solvent and other additives used. The estimated theoretical VOC of the coating formulation may be less than about 900, 800, 700, 600, 500, 450, 400, 350, 300, 250, 200, 150, or 100 gm/1, depending on the solvent and other additives used. The VOC (gm/l) may be provided in a range between any two of these values, for example 100 and 900, 150 and 500, or 100 and 700.

(A) Organic Polymer with Acid Functionalities

The selectively strippable coating composition comprises one or more organic polymers comprising carboxylic acid functionalities. As used herein, “carboxylic acid functionality” refers to any chemical moiety that is capable of functioning as a carboxylic acid or can form a carboxylic acid group in situ. The carboxylic acid functionalities may include carboxylic acid groups (e.g. —COOH). In some embodiments, the carboxylic acid group may be formed in situ from a precursor hydrolysable to form carboxylic acid functionality, such as an anhydride precursor. In one particular embodiment, the carboxylic acid functionality comprises or consists of a carboxylic acid group. In one example, the carboxylic acid functionality is a carboxylic acid group. The one or more organic polymers comprising carboxylic acid functionalities may be provided as a mixture of two or more polymers or copolymers (e.g. blend of two or more different polymers). It will be appreciated that the term “polymer” can include “copolymers”. The organic polymer comprising acid functionalities may be a copolymer, for example wherein at least one comonomer comprises acid functionalities.

The one or more organic polymers comprising carboxylic acid functionalities may be selected from the group consisting of polyurethane, polyamide, polyether, polyester, polyolefin, co-polymers thereof, and blends thereof. It will be appreciated that each of these polymers contain carboxylic acid functionalities, for example prepared or modified to contain carboxylic acid functionalities, such as by using particular comonomers or by grafting on carboxylic acid functionalities. The one or more organic polymers comprising carboxylic acid functionalities may be independently selected from a copolymer of polyurethane, polyamide, polyether, polyester, and polyolefin. In one example, the one or more organic polymers comprising carboxylic acid functionalities is independently selected from a carboxylic acid copolymer of polyurethane, polyamide, polyether, polyester, and polyolefin. In one example, the one or more organic polymers comprising carboxylic acid functionalities are selected from at least one of a polyurethane. In one example, the one or more organic polymers comprising carboxylic acid functionalities are selected from at least one of a polyurethane and a polyolefin. The polyolefin may be a polyethylene, for example a polyethylene co-acrylic acid copolymer. In another example, the one or more organic polymers comprising carboxylic acid functionalities are selected from at least one of a polyurethane and polyethylene, each being a carboxylic acid copolymer thereof. In another example, the one or more organic polymers comprising carboxylic acid functionalities comprise or consist of a polyurethane co-carboxylic acid copolymer. In another example, the one or more organic polymers comprising carboxylic acid functionalities comprise or consist of a polyethylene co-acrylic acid copolymer (PEAA). In another example, the carboxylic acid functionalities in the organic polymer, such as carboxylic acids in polyurethane and/or PEAA, may be provided in any of the wt % amounts or ranges of the organic polymer as previously described above.

The carboxylic acid functionality can be incorporated into the organic polymer by any means known to the person skilled in the art. For example, the carboxylic acid functionality can be incorporated by copolymerisation, grafting copolymerisation with monomers containing acid functionalities or through post-synthesis modification of the polymer by incorporating acid functionalities into the polymer back-bone. The carboxylic acid functionalities may be provided as pendant groups linked to the polymer chain by alkyl groups, for example straight chain or branched C₁₋₁₀alkyl groups substituted with a carboxylic acid group, or directly attached to the polymer chain as a carboxylic acid moiety.

In some embodiments, the organic polymer may be an acrylic grafted copolymer comprising grafted nylon, polyether or polyester. Typically grafted polymers can be prepared by reacting an activated polymer backbone with a monomer and thermal initiator at an elevated temperature, for example below Scheme 1:

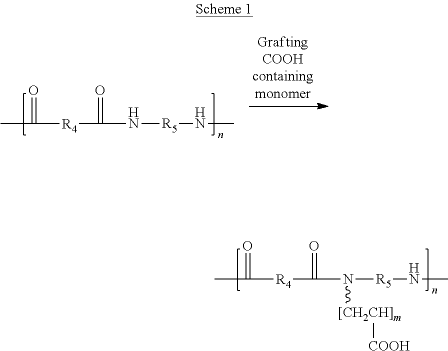

In the above example R₄ and R₅ can each independently be C_{1-X}alkyl, C_{1-X} alkylaryl or aryl, and where X is a positive integer. X may for example be 22, 20, 18, 16, 14, 12, 10, 8, 6, 4 or 2. It will be appreciated that the grafted polymers can also be prepared using other techniques known to the person skilled in the art.

Non-limiting examples of comonomers containing carboxylic acid functionalities include acrylates such as C₁₋₄ alkyl acrylate, crotonic acid, vinyl benzoic acid, 2-bromoacrylic acid, 2-bromomethacrylic acid, fumaric acid, maleic acid, itaconic acid and muconic acid. In some embodiments, the comonomer containing carboxylic acid functionality is selected from the group consisting of acrylic acid and methacrylic acid. In some examples, the comonomer containing carboxylic acid functionality is acrylic acid. In some examples, the organic polymer comprising carboxylic acid functionalities is a reactant product of an acrylic acid comonomerand olefin comonomer, such as a PEAA as described herein.

In one example or embodiment, the organic polymer is selected from the group consisting of a polyurethane having carboxylic acid functionalities, polyether having carboxylic acid functionalities, polyester having carboxylic acid functionalities, a polyamide having carboxylic acid functionalities, a polyolefin having carboxylic acid functionalities, or any copolymer or blend thereof. In another example or embodiment, the organic polymer is selected from the group consisting of a polyurethane having carboxylic acid functionalities, a polyolefin having carboxylic acid functionalities and a polyamide having carboxylic acid functionalities. In one particular embodiment, the organic polymer comprises or consists of at least one of a polyurethane having carboxylic acid functionalities and a polyolefin having carboxylic acid functionalities. The polyolefin having carboxylic acid functionalities may be a polyethylene acrylic acid.

As mentioned, in some embodiments the organic polymer comprises a polyurethane having carboxylic acid functionalities. The polyurethane can be formed by a reaction of an isocyanate and a diol and/or polyol, generally in the presence of a chain extender, catalyst, and/or other additives. For example, the polyurethane can be synthesized by dissolving anhydrous acid diol(s) and/or polyol(s) in a solvent (such as tetrahydrofuran (THF), dimethylformamide (DMF), dimethylacetamide (DMAc), N-Methyl-2-pyrrolidone (NMP), acetone, methyl butyl ketone (MEK)), and then adding the diisocyanate(s) at 50-80° C. After the reaction is complete, aqueous amine solution can be added to make a polyurethane dispersion. If required, the solvent may be removed by evaporation under reduced pressure.

Suitable acid diols useful for preparing the polyurethane polymers include, but are not limited to, diols having a carboxylic functionality, such as 2,2-dihydroxy-methyl butanoic acid (DMBA), dimethylol acetic acid (DMAA), dimethylol propionic acid (DMPA), dimethylol pentanoic acid (dimethylol valeric acid) (DMVA) and di-methylol hexanoic acid (dimethylol caproic acid) (DMCA).

Suitable polyols include low-molecular-weight polyols. In some embodiments, the polyol is selected from the group consisting of polyethylene glycol, polypropylene glycol and copolymer of ethylene oxide and propylene oxide, and polytetrahydrofuran. Other suitable polyols include, but are not limited to polyester polyol, polyether polyol, polycarbonate polyol manufactured by the esterification between carbonic acid and aliphatic polyhydric alcohol, polyesteramide polyol, polyacetal polyol, polythioether polyol and polybutadiene glycol polyol. In some embodiments, the number average molecular weight of the polyol is in the range of 300 to 5000. In other embodiments, the number average molecular weight of the polyol is in the range of 400 to 2000. Polyols can be used singly or in combination of two or more.

Chain extenders include low molecular weight polyols and amines. Low-molecular-weight polyols include, but are not limited to, ethylene glycol, propylene glycol, 1,4-butanediol, 1,5-pentanediol, 3-methyl-1,5-pentanediol, 1,6-hexanediol, neopentyl glycol, diethylene glycol, triethylene glycol, tetraethylene glycol, dipropylene glycol, tripropylene glycol, 1,4-cyclohexane diol and 1,4-cyclohexane dimethanol. Amines include, but not limited to, ethylendiamine, butanediamine, hexanediamine, 1,3-diaminopentane, isophorone diamine, piperazine, Jeffamine polyetheramines.

Suitable polyisocyanates include any polyisocyanates which are commonly usable for manufacturing a water-dispersible polyurethane resin, such as aromatic polyisocyanates, alicyclic polyisocyanates and aliphatic polyisocyanates.

Non-limiting examples of aromatic polyisocyanates include 1,3- and 1,4-phenylene diisocyanate, 1-methyl-2,4-phenylene diisocyanate (2,4-TDI), 1-methyl-2,6-phenylene diisocyanate (2,6-TDI), 1-methyl-2,5-phenylene diisocyanate, 1-methyl-2,6-phenylene diisocyanate, 1-methyl-3,5-phenylene diisocyanate, 1-ethyl-2,4-phenylene diisocyanate, 1-isopropyl-2,4-phenylene diisocyanate, 1,3-dimethyl-2,4-phenylene diisocyanate, 1,3-dimethyl-4,6-phenylene diisocyanate, 1,4-dimethyl-2,5-phenylene diisocyanate and diethylbenzene diisocyanate, diisopropylbenzene diisocyanate, 1-methyl-3,5-diethylbenzene diisocyanate, 3-methyl-L5-diethylbenzene-2,4-diisocyanate, 1,3,5-triethylbenzene-2,4-diisocyanate, naphthalene-1,4-diisocyanate, naphthalene-1,5-diisocyanate, 1-methyl-naphthalene-1,5-diisocyanate, naphthalene-2,6-diisocyanate, naphthalene-2,7-diisocyanate, 1,1-dinaphthyl-2,2′-diisocyanate, biphenyl-2,4′-diisocyanate, biphenyl-4,4′-diisocyanate, 3,3′-dimethylbiphenyl-4,4′-diisocyanate, diphenylmethane-4,4′-diisocyanate (4,4-MDI), diphenylmethane-2,2′-diisocyanate (2,2-MDI) and diphenylmethane-2,4-diisocyanate (2,4-MDI).

Non-limiting examples of alicyclic polyisocyanates and aliphatic polyisocyanates include tetramethylene diisocyanate, 1,6-hexamethylene diisocyanate (HDI), dodecamethylene diisocyanate, trimethyl hexamethylene diisocyanate, 1,3-cyclopentylene diisocyanate, 1,3-cyclohexylene diisocyanate, 1,4-cyclohexylene diisocyanate, 1,3-di(isocyanate methyl)cyclohexane, 1,4-di(isocyanate methyl)cyclohexane, lysine diisocyanate, isophorone diisocyanate (IPDI), 4,4′-dicyclohexylmethanediisocyanate (4,4-HMDI), 2,4′-dicyclohexylmethane diisocyanate (2,4-HMDI), 2,2′-dicyclohexylmethane diisocyanate (2,2-H-MDI), 3,3′-dimethyl-4,4′-dicyclohexylmethane diisocyanate and trimers thereof.

In some embodiments, the polyisocyanates are selected from the group consisting of 1-methyl-2,4-phenylene diisocyanate (2,4-TDI), 1-methyl-2,6-phenylene diisocyanate (2,6-TDI), 1,3-dimethyl-2,4-phenylene diisocyanate, 1,3-dimethyl-4,6-phenylene diisocyanate and 1,4-dimethyl-2,5-phenylene diisocyanate, diphenylmethane-4,4′-diisocyanate (4,4-MDI), diphenylmethane-2,2′-diisocyanate (2,2-MDI), diphenylmethane-2,4-diisocyanate (2,4-MDI), 1,6-hexamethylene diisocyanate (HDI), isophorone diisocyanate (IPDI), 4,4′-dicyclohexylmethane diisocyanate (4,4-H-MDI), 2,4′-dicyclohexylmethane diisocyanate (2,4-H-MDI) and 2,2′-dicyclohexylmethane diisocyanate (2,2-HDI), lysine diisocyanate (LDI) and mixtures thereof.

Suitable polyurethanes include, but are not limited to, a polyurethane copolymer containing tertiary carboxylic acid functional groups which can be dispersed in water by reaction with suitable amines. For example, the polyurethane may be an acid containing polyurethane comprising one or more groups independently selected from formula (1):

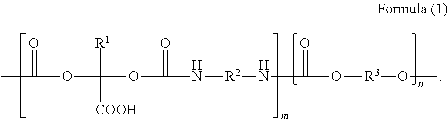

In an example of the above Formula (1), R¹ is an alkyl group, R² is derived from any selected polyiisocyanate as previously described and R³ is derived from any selected polyol as previously described, m and n are positive integers and are independently between 1-200, for example from 10 to 100, or from 20 to 50 and m:n can be varied from 0.01 to 5, for example from 0.1 to 1 or from 0.2 to 0.5. In another example of the above Formula (1), le is a C₁₋₆ alkyl group, R² is derived from any selected polyiisocyanate as previously described and R³ is derived from any selected polyol as previously described, m and n are positive integers and are independently between 1-200, for example from 10 to 100, or from 20 to 50 and m:n can be varied from 0.01 to 5, for example from 0.1 to 3 or from 0.5 to 2.5

In some embodiments, the polyurethane may be an acid containing polyurethane comprising one or more groups independently selected from formula (2):

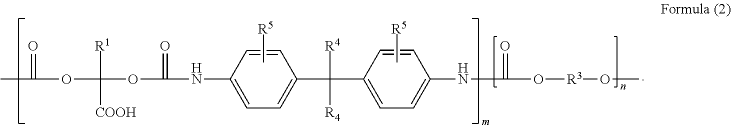

In an example of the above Formula (2), R¹ is an alkyl group, R³ is derived from any selected polyol as previously described, R⁴ is independently hydrogen or alkyl, R⁵ is independently hydrogen or alkyl, m and n are positive integers and are independently between 1-200, for example from 10 to 100 or from 20 to 50 and m:n can be varied from 0.01 to 5, for example from 0.1 to 1 or from 0.2 to 0.5. In another example of the above Formula (2), wherein R¹ is C₁₋₆ alkyl group, R³ is derived from any selected polyol as previously described, R⁴ is independently hydrogen or C₁₋₆alkyl, R⁵ is independently hydrogen or C₁₋₆ alkyl, m and n are positive integers and are independently between 1-200, for example from 10 to 100 or from 20 to 50 and m:n can be varied from 0.01 to 5, for example from 0.1 to 1 or from 0.2 to 0.5.

An example of polyurethane having carboxylic acid functionalities is a polyurethane obtained from the condensation reaction of 2,2-Bis(hydroxymethyl)butyric acid (DMBA), disocyanate, polyol and chain extender comprises DMBA from 5% w/w to 25% w/w and molecular weight (wt) 5000 to 100000.

As mentioned, in some embodiments the organic polymer comprises a polyamide having carboxylic acid functionalities. The organic polymer may be a grafted nylon copolymer comprising one or more groups independently selected from formula (3):

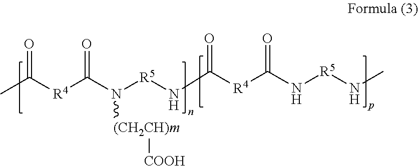

wherein R⁴ and R⁵ are each independently C₁₋₁₂ alkyl or phenyl. In some embodiments, R₄ and R⁵ are each independently C₄₋₆ alkyl or aryl, for example phenyl. In some embodiments, R⁴ is —(CH₂)₄— and R⁵ is —(CH₂)₆—. In some embodiments, the nylon is selected from the group consisting of PA6, PA66, PA6/66 and PA66/610. In some embodiments, the nylon is a copolymer that can be dissolved in an aqueous alcohol solution, such as Elvamide 8061, 8063 and 8066 (nylon multipolymer of nylon-6, -66 and -610) from DuPont.

In some embodiments, the organic polymer is acrylic polymer containing carboxylic acid functionalities. Suitable acrylic polymer containing carboxylic acid functionalities are described and referred to U.S. Pat. No. 9,604,253. In one example, the acrylic polymers are polyethylene-co-(meth)acrylic acid.

In another example, the one or more organic polymers comprises a copolymer of at least one unsaturated acid monomer with an olefinic hydrocarbon monomer, which can include polyolefins having acid functionalities as described herein. Suitable unsaturated acid monomer include, but are not limited to, olefinic hydrocarbon monomers including ethylene, propylene or combinations thereof, for example polyethylene having carboxylic acid functionalities. In some embodiments, the polyolefin having carboxylic acid functionalities comprises greater than about 9% w/w, 11% w/w, 13% w/w, 15% w/w, 17% w/w, or 20% w/w, of acid monomer. In some embodiments, the polyolefin having carboxylic acid functionalities comprises less than about 30% w/w, 25% w/w, 20% w/w, or 15% w/w, of acid monomer. The acid monomer may be provided in an amount between any two of these upper and/or lower ranges. In some embodiments, the polyolefin having carboxylic acid functionalities comprises between about 15% to 30% w/w acid monomer.

In some embodiments, the polyolefin having carboxylic acid functionalities comprises a copolymer or oligomer of ethylene, propylene or styrene with acrylic, (meth)acrylic or maleic anhydride, for example copolymers of styrene-co-maleic anhydride (PSMA) or ethylene-co-acrylic acid (PEAA), such as polyethylene co-acrylic acid copolymer. In some embodiments, the polyolefin having carboxylic acid functionalities is a copolymer of at least one of acrylic acid and methacrylic acid with an olefin selected from ethylene and propylene. Ethylene-acrylic acid and ethylene-methacrylic acid copolymers are described in U.S. Pat. Nos. 4,599,392, 4,988,781, 9,604,253, and are incorporated herein by reference. In one embodiment, the polyolefin having acid functionalities is polyethylene-co-acrylic acid copolymer. In some embodiments, the polyethylene-co-acrylic acid copolymer comprises greater than about 9% w/w, 11% w/w, 13% w/w, 15% w/w, 17% w/w, or 20% w/w, of acrylic acid. In some embodiments, the polyethylene-co-acrylic acid copolymer comprises less than about 30% w/w, 25% w/w, 20% w/w, or 15% w/w, of acrylic acid. The acrylic acid may be provided in an amount between any two of these upper and/or lower ranges. In some embodiments, the polyethylene-co-acrylic acid copolymer comprises between about 15% to 30% w/w acrylic acid.

An example polyolefin having carboxylic acid functionalities is PRIMACOR® 5990I copolymer (20% w/w acrylic acid, P5990), which has a melt index of 1300 g/10 minute (ASTM Method D-1238 at 190° C.) and a Brookfield viscosity of 13,000 cps at 350° F., and is available from The Dow Chemical Company. Another example polyolefin having carboxylic acid functionalities is PRIMACOR® 5980I copolymer (20.5% w/w acrylic acid, P5980), which has a melt index of 300 g/10 minute (ASTM Method D-1238 at 190° C.), available from The Dow Chemical Company. Another example polyolefin having carboxylic acid functionalities is available under the tradename NUCREL® 2806, from E.I. du Pont de Nemours and Company, Inc.

The amount of polyolefin having acid functionalities can vary depending on the desired properties of the selectively strippable coating. Without wishing to be bound by any theory, it is thought that the inclusion of a polyolefin having carboxylic acid functionalities can help to reduce stripping time. In some embodiments, the selectively strippable coating comprises a polyolefin having carboxylic acid functionalities of between about 1 and 30%, 2 and 25%, between 5 and 25%, or between about 10 and 20% (based on the weight of the one or more organic polymers).

In some embodiments, the organic polymer is a water soluble or water dispersible polymer. In some embodiments, the organic polymer can be dissolved in an aqueous alcohol solution. Suitable alcohols include, but are not limited to, methanol, ethanol, 2-propanol, 1-propanol, 1-butanol, benzyl alcohol, furfuryl alcohol, phenol, and m-cresol. In some embodiments, the organic polymer can be dissolved or dispersed in water by the addition of amines.

The carboxylic acid content of the polymer can be measured by determining the acid value of the polymer. The acid value of a polymer can be determined by any method known to a person skilled in the art. For example, the acid value may be calculated by determining the amount of potassium hydroxide (in milligrams) required to neutralize one gram of polymer. In some examples, the acid value of the organic polymer is from 10 to 400, from 10 to 300, from 20 to 250, or from 30 to 200. In some examples, the acid value of the organic polymer is at least about 10, 20, 30, 40, 50, 60, 70, 80, 90, 100, 125, 150, 175, or 200. In some examples, the acid value of the organic polymer is less than about 400, 375, 350, 325, 300, 275, 250, 225, 200, 175, or 150. The acid value of the organic polymer may be in a range provided by any two of these upper and/or lower values. It will be appreciated that these acid values apply for the various acid groups for the various organic polymers as described herein, for example carboxylic acid groups present on a polyurethane or polyolefin.

In some embodiments, the molecular weight of the organic polymer can be selected by the person skilled in the art to maintain solubility for ease of application or improve in-service adhesion for particular substrates, for example coated composites. In some examples, the organic polymer has a number average molecular weight of at least about 5000, 7500, 10000, 12500, 15000, 17500, 20000, 25000, or 50000. In some examples, the organic polymer has a number average molecular weight of less than about 500000, 400000, 300000, 200000, 100000, 75000, or 50000. The organic polymer may have a number average molecular weight in a range provided by any two of these upper and/or lower values, for example a number average molecular weight in a range of 5,000 to 100,000, 7500 to 200000, or 10000 to 100000.

In some examples, the organic film former or one or more organic polymers comprising carboxylic acid functionalities may be provided by a blend of two or more polymers. The polymer blend may comprise or consist of one or more organic polymers comprising carboxylic acid functionalities selected from the group consisting of polyurethane, polyamide, polyether, polyester, and polyolefin, and one or more organic polymers selected from the group consisting of polyurethane, polyamide, polyether, polyester, and polyolefin. The polymer blend may comprise or consist of two or more organic polymers comprising carboxylic acid functionalities selected from the group consisting of polyurethane, polyamide, polyether, polyester, and polyolefin.

In some examples, the selectively strippable coating composition comprises two or more organic polymers comprising carboxylic acid functionalities, such as a polymer blend. The polymer blend may comprise or consist of two or more organic polymers comprising carboxylic acid functionalities selected from the group consisting of polyurethane, polyamide, polyether, polyester, and polyolefin. In some examples, the selectively strippable coating composition comprises a polymer blend of carboxylic copolymers of each of polyurethane and polyolefin. In some examples, the selectively strippable coating composition comprises a carboxylic acid containing polyurethane and a carboxylic acid containing acrylic copolymer.

In some examples, the polyurethane comprising carboxylic acid functionalities according to any examples thereof as described herein may be provided in a blend with another polymer, for example at least one of the other organic polymers comprising acid functionalities according to any examples thereof as described herein. In another example, the polyurethane comprising acid functionalities according to any examples thereof as described herein is provided in a blend with a polyolefin and/or acrylic acid copolymer. The amount of the polyurethane in the blend (as a wt % of the total polymer blend) may at least about 10, 15, 20, 25, 30, 25, 40, 45, 50, 55, 60, 65, 70, 75, 80, 85, or 90. In one example, the amount of the polyurethane in the blend (as a wt % of the total polymer blend) may provide the major polymer component in the polymer blend, for example at least about 50 wt % of the total polymer blend. The amount of the polyurethane in the blend (as a wt % of the total polymer blend) may be less than about 95, 90, 85, 80, 75, 70, 65, 60, 55, 50, 45, 40, 35, 30, 25, 20, or 15. The amount of the polyurethane in the blend (as a wt % of the total polymer blend) may be provided in a range between any two of these upper and lower values, for example between about 50 and 95, 60 and 95, or 70 and 90. It will be appreciated that the other organic polymers comprising carboxylic acid functionalities in the polymer blend, such as the polyolefin or acrylic acid copolymer, may each independently or collectively provide a remainder amount in the polymer blend. The organic film former or the one or more organic polymers may be provided by one of the two following example organic polymer blends:
60 to 95 wt % of a polyurethane containing carboxylic acid groups and 5 to 40 wt % of a polyolefin or acrylic acid copolymer containing carboxylic acid groups, or
70 to 90 wt % of a polyurethane containing carboxylic acid groups and 10 to 30 wt % of a polyolefin or acrylic acid copolymer containing carboxylic acid groups.

In some examples, the organic film former or the total amount of the organic polymer comprising carboxylic acid functionalities is provided in the coating composition in an amount of about 1 to 30 wt % based on the weight of the composition. In some examples, the organic film former or the organic polymer may be provided in the coating composition in an amount (based on wt % of the composition) of about 3 to 25, 5 to 25, or 10 to 20. In some examples, the organic film former or the one or more organic polymers comprising carboxylic acid functionalities may be provided in the coating composition in an amount (based on wt % of the composition) of at least about 1, 2, 3, 4, 5, 6, 7, 8, 9, 10, 11, 12, 13, 14, or 15. In some examples, the organic film former or the organic polymer may be provided in the coating composition in an amount (based on wt % of the composition) of less than about 30, 28, 26, 24, 22, 20, 19, 18, 17, 16, 15, 14, 13, 12, 11, 10, 9, 8, 7, 6, 5, 4, 3, or 2. The organic film former or the organic polymer may be provided in the composition in a range provided by any two of the above upper and/or lower ranges, for example in a range of about 1 and 30, 2 and 20, or 5 and 25.

### (B) Metallic Agent

The selectively strippable coatings and compositions of the present disclosure comprise a metallic agent. Metallic agents useful in the coatings and compositions described herein are metals or metal compounds comprising a metal capable of binding to the carboxylic acid functionalities of the organic polymer. Suitable metals include transition metals such as zinc, copper, nickel, zirconium, titanium, vanadium and tungsten. In some examples, the metal is selected from the group consisting of zinc, copper and nickel. In some examples, the metallic agents are selected from the group consisting of zinc and copper. In one example, the metallic agent comprises zinc, which may be an oxide, hydroxide or salt thereof.

The metallic agent may comprise a metal that is selected a transition metal. It will be appreciated that the transition metal may be selected from Groups 3 to 12 of the Periodic table. For example, the metallic agent may comprise a non-alkaline metal, which would exclude the metallic agent from containing any alkali metals such as sodium or alkaline earth metals such as calcium. The metallic agent may comprise one or more metals, wherein the one or more metals consist of a transition metal. The metallic agent may comprise a metal selected from the group consisting of zinc, copper, nickel, zirconium, titanium, vanadium, tungsten, and any combinations thereof. The metallic agent may be in the form of a metal complex or salt, such as a metal oxide or salt thereof. For example, the metal may be zinc or an oxide or salt thereof. The metal salt may be an amine metal hydroxide, such as tetraamine zinc hydroxide. In one example, the metallic agent is zinc oxide (ZnO). In another example, the boron agent is boric acid. In another example, the metallic agent is zinc oxide and the boron agent is boric acid (BA). The metallic agent may further comprise boron. The metallic agent may comprise boron and one or more metals, wherein the one or more metals consist of a transition metal as described herein.

In some examples, the metallic agent is a metal oxide, metal hydroxide, metal salt or metal complex, for example an organo-metallic compound. In some examples, the metallic agent may be in the form of a metal oxide, hydroxide or salt.

In one example, the metallic agent is a metal hydroxide, such as a zinc hydroxide, for example tetraamine zinc hydroxide. In another example, the metallic agent is zinc oxide, such as ZnO.

The metallic agent can be derived from the same compound or agent as for the boron agent, for example a metal-boron complex or salt. The metallic agent may be provided as a reaction product of a metallic agent and a boron agent according to any examples of those individual agents as described herein. In other words, the metallic agent may be a boron-metal complex or salt as described herein.

In some embodiments, the metallic agent is a metal oxide. Suitable metal oxides include oxides of the transition metals zinc, copper, nickel, zirconium, titanium, vanadium, tungsten. In some embodiments, the metal oxides may be selected from the group consisting of zinc, copper and nickel oxide. In some embodiments, the metal oxides may be selected from the group consisting of zinc and copper oxide. In one example, the metal oxide is zinc oxide. At least according to some embodiments or examples, the inventors have found that improved intercoat adhesion can be provided when the metallic agent is a metal oxide.

In some embodiments, the metallic agent is a metal hydroxide. Suitable metal hydroxides include hydroxides of transition metals such as zinc, copper, nickel and zirconium. In some embodiments, the metal hydroxides may be selected from the group consisting of zinc, copper, and nickel. In some embodiments, the metal hydroxides may be selected from the group consisting of zinc and copper. In one example, the metal hydroxide is zinc hydroxide.

In some embodiments, the metal oxide and/or metal hydroxide may be dissolved in an ammonia solution to form metal ammonia hydroxide complex in solution.

In some embodiments, the metallic agent is a metal acetate, chloride, nitrate or sulfate. The metal salt can be reacted with a base forming metal hydroxide. The metal hydroxide can be dissolved in an ammonia solution to form a metal ammonia hydroxide complex in solution. Suitable metal salts include salts of transition metals such as zinc, copper, nickel, and zirconium. In some embodiments, the metallic agent may be selected from the group consisting of salts of zinc, copper and nickel. In some embodiments, the metallic agent may be selected from the group consisting of salts of zinc and copper. In one example, the metallic agent is a zinc salt.

Without wishing to be bound by any theory, it is believed that the metal in the metallic agent binds to the acid functionality in the organic polymer forming reversible crosslinks. In some examples, the molar ratio (M:A) of metallic agent (M) to the acid functionality (A) of the organic polymer may be at least about 10:1, 9:1, 8:1, 7:1, 6:1, 5:1, 4:1, 3:1, 2:1, or 1:1. In some examples, the molar ratio (M:A) of metallic agent (M) to the acid functionality (A) of the organic polymer may be less than about 1:10, 1:9, 1:8, 1:7, 1:6, 1:5, 14:4, 1:3, 1:2, or 1:1. The molar ratio (M:A) of metallic agent (M) to the acid functionality (A) of the organic polymer may be in a range provided by any two of these upper and/or lower values. In some examples, the molar ratio (M:A) of metallic agent (M) to the acid functionality (A) of the organic polymer may be in the range of 10:1 (M:A) to 1:10 (M:A), in the range of 5:1 (M:A) to 1:5 (M:A), or in the range of 2.5:1 (M:A) to 1:2.5 (M:A). In one example, the molar ratio (M:A) of metallic agent (M) to the acid functionality (A) of the organic polymer is in a range of 2:1 to 1:2.

The metallic agent unexpectedly enables a coating formulation to be prepared that has a high concentration of metallic agent (e.g. zinc oxide). The metallic agent may be provided in the coating formulation between 0.02 to 2% (based on wt % of composition or formulation), for example between 0.1 to 1% or between 0.15 to 0.6%. The metallic agent may be provided in the coating formulation in at least about 0.1, 0.15, 0.2, 0.25, 0.3, 0.35, 0.4, 0.45, 0.5, 0.55, 0.6, 0.7, 0.8, 0.9, or 1% (based on the weight of the coating formulation). The metallic agent may be provided in the coating formulation in less than 2.0, 1.8, 1.6, 1.4, 1.2, 1.0, 0.9, 0.8, 0.7, 0.6, 0.55, 0.5, 0.45, 0.4, 0.35, 0.3, 0.25, 0.2, 0.15, 0.1% (based on the weight of the coating formulation). The metallic agent may be provided in the coating formulation in an amount range between any two of these upper and/or lower values, for example 0.1 to 2%, 0.2 to 1%, or 0.3 to 0.9%.

In some embodiments, the metallic agent is provided in the strippable coating (dry coating prepared from the coating formulation) in an amount of about 0.5 to 25 (based on wt % of the composition of the dry coating), for example between 0.5 to 20% or between 2 to 15%. The metallic agent may be provided in the composition to provide an amount in a dry coating thereof (based on wt % of the composition of the dry coating) of at least about 1, 2, 3, 4, 5, 6, 7, 8, 9, 10, 12, or 14%. The metallic agent may be provided in the composition to provide an amount in a dry coating thereof (based on wt % of the composition of the dry coating) of less than about 25, 20, 18, 16, 14, 12, 10, 8, 6, 4, or 2%. The metallic agent may be provided in the coating composition in an amount range between any two of these upper and/or lower values.

### (C) Boron Agent

The coatings and compositions of the present disclosure comprise a boron agent. As used herein, a “boron agent” is a compound which contains boron. Without wishing to bound by any theory, it is believed that the boron agent acts a co-complexing agent and forms coordination complexes with the metal and acid functionality creating co-cross-links within the selectively strippable coating. It is also believed that at least according to some embodiments, the boron agent improves the solubility of the metallic agent in the coating composition. Accordingly, in at least some embodiments and examples the boron agent may increase the amount of metallic agent present in the coating, reduce the amount of ammonia required to solubilise the metallic agent and/or improve the application and performance of the formulations during curing and adhesion on coated substrates and subsequent removal following in service use.

The boron agent may be a boron compound selected from one or more of boron hydride, boron hydroxide, boron oxide, ammonium salt thereof, and metal borate thereof. The boron agent may be an acidic boron agent, such as an agent capable of providing a Lewis acid and Bronsted acid. The boron agent may be a metallic agent comprising boron according to any examples as described herein. The boron agent can be dissolvable in an ammonia solution, which can facilitate formation of a co-complex structure with the metallic agent according to examples as described herein. In some examples, the boron agent is selected from one or more of a diborane, boric acid, boronic acid, ammonium borate, and zinc borate.

The boron agent can be derived from the same compound or agent as for the metallic agent, for example a metal-boron complex or salt. The metallic agent may be provided as a reaction product of a metallic agent and a boron agent according to any examples of those individual agents as described herein. In other words, the metallic agent may be a boron-metal complex or salt as described herein.

The amount of boron agent can vary depending on the desired properties of the selectively strippable coating.

In some examples, the molar ratio (M:B) of metallic agent (M) to boron agent (B) may be at least about 10:1, 9:1, 8:1, 7:1, 6:1, 5:1, 4:1, 3:1, 2:1, or 1:1. In some examples, the molar ratio (M:B) of metallic agent (M) to boron agent (B) may be less than 1:10, 1:9, 1:8, 1:7, 1:6, 1:5, 1:4, 1:3, 1:2, or 1:1. The molar ratio (M:B) of metallic agent (M) to boron agent (B) may be in the range provided by any two of these upper and/or lower values, for example between 10:1 (M:B) to 1:10 (M:B), 5:1 (M:B) to 1:5 (M:B), or 2:1 (M:B) to 1:2 (M:B). In one example, the M:B ratio is about 1:1. These ratios of metal agent to boron agent can facilitate improved solubility of the metal agent, formation of the metal complex, or cross-linking in the coating, that can achieve in at least some examples good in service adhesion of coatings and removal/stripping under the environment conditions as described herein.

In some embodiments, the boron agent is provided in the coating composition in an amount of about 0.02 to 2% (based on total wt % of the compositions or formulation), for example between 0.1 to 1% or between 0.15 to 0.6. The boron agent may be provided in the coating formulation in an amount (based on wt % of the composition or formulation) of at least about 0.1, 0.15, 0.2, 0.25, 0.3, 0.35, 0.4, 0.45, 0.5, 0.55, 0.6, 0.7, 0.8, 0.9, or 1% (based on the weight of the coating formulation). The boron agent may be provided in the coating formulation less than about 2.0, 1.8, 1.6, 1.4, 1.2, 1.0, 0.9, 0.8, 0.7, 0.6, 0.55, 0.5, 0.45, 0.4, 0.35, 0.3, 0.25, 0.2, 0.15, 0.1% (based on the weight of the coating formulation). The boron agent may be provided in the coating formulation in an amount range between any two of these upper or lower values. It will be appreciated that these amount examples can also be applicable when the boron agent is provided in a metal-boron complex as described herein.

In some embodiments, the boron agent is provided in the strippable coating (dry coating prepared from the coating formulation) in an amount of about 0.5 to 25 (based on wt % of the composition of the dry coating), for example between 0.5 to 20% or between 2 to 15%. The boron agent may be provided in the composition to provide an amount in a dry coating thereof (based on wt % of the composition of the dry coating) of at least about 1, 2, 3, 4, 5, 6, 7, 8, 9, 10, 12, or 14%. The boron agent may be provided in the composition to provide an amount in a dry coating thereof (based on wt % of the composition of the dry coating) of less than about 25, 20, 18, 16, 14, 12, 10, 8, 6, 4, or 2%. The boron agent may be provided in the coating composition in an amount range between any two of these upper and/or lower values. It will be appreciated that these amount examples can also be applicable when the boron agent is provided in a metal-boron complex as described herein.

### (D) Metal-Boron Complex

As previously mentioned, the metallic agent and boron agent can be derived from the same compound or agent, for example a metal-boron complex or salt. The metal-boron complex or salt comprises one or more metal atoms and one or more boron atoms. The metal in the metal-boron complex may be selected from a transition metal, for example one or more of zinc, copper, nickel, zirconium, titanium, vanadium, and tungsten. The metal-boron complex may comprise one or more boron atoms and one or more metals, wherein the one or more metals consist of a transition metal according to any examples or embodiments as described herein. In another example, the metal may be zinc or an oxide thereof. The boron-metal complex or salt may be prepared or provided in-situ as a reaction product of the metallic agent and boron agent according to any examples of those individual agents as described herein. The metal-boron complex or salt may be a metal borate, such as a zinc borate. The metal-boron complex can be in the form an oxide, for example a complex comprising or consisting of boron, zinc and oxygen atoms. In one example, the metal-boron complex is a reaction product of ZnO and BA, which may be referred to as ZnO:BA. In one example, the metal-boron complex is zinc borate, for example Zinc borate Firebrake® ZB (2ZnO.3B₂O₃.3.5H₂O), Zinc borate Firebrake® 500 (2ZnO.3B₂O₃), Zinc borate Firebrake® 415 (4ZnO.B₂O₃.H₂O), ZB-467 (4ZnO.6B₂O₃.7H₂O), ZB-223 (2ZnO.2B₂O₃.3H₂O).

In some examples, the metal-boron complex or salt thereof may be provided in the coating formulation between 0.02 to 2% (based on wt % of composition or formulation), for example between 0.1 to 1% or between 0.15 to 0.6%. The metal-boron complex or salt thereof may be provided in the coating formulation in at least about 0.1, 0.15, 0.2, 0.25, 0.3, 0.35, 0.4, 0.45, 0.5, 0.55, 0.6, 0.7, 0.8, 0.9, or 1% (based on the weight of the coating formulation). The metal-boron complex or salt thereof may be provided in the coating formulation in less than 2.0, 1.8, 1.6, 1.4, 1.2, 1.0, 0.9, 0.8, 0.7, 0.6, 0.55, 0.5, 0.45, 0.4, 0.35, 0.3, 0.25, 0.2, 0.15, 0.1% (based on the weight of the coating formulation). The metal-boron complex or salt thereof may be provided in the coating formulation in an amount range between any two of these upper and/or lower values, for example 0.1 to 2%, 0.2 to 1%, or 0.3 to 0.9%.

In some embodiments, the metal-boron complex or salt thereof is provided in the strippable coating (dry coating prepared from the coating formulation) in an amount of about 0.5 to 25 (based on wt % of the composition of the dry coating), for example between 0.5 to 20% or between 2 to 15%. The metal-boron complex or salt thereof may be provided in the composition to provide an amount in a dry coating thereof (based on wt % of the composition of the dry coating) of at least about 1, 2, 3, 4, 5, 6, 7, 8, 9, 10, 12, or 14%. The metal-boron complex or salt thereof may be provided in the composition to provide an amount in a dry coating thereof (based on wt % of the composition of the dry coating) of less than about 25, 20, 18, 16, 14, 12, 10, 8, 6, 4, or 2%. The metal-boron complex or salt thereof may be provided in the coating composition in an amount range between any two of these upper and/or lower values.

In some examples, the molar ratio (M:B) of metal (M) to boron (B) in the metal-boron complex may be at least about 10:1, 9:1, 8:1, 7:1, 6:1, 5:1, 4:1, 3:1, 2:1, or 1:1. In some examples, the molar ratio (M:B) of metal (M) to boron (B) in the metal-boron complex may be less than about 1:10, 1:9, 1:8, 1:7, 1:6, 1:5, 1:4, 1:3, 1:2, or 1:1. The molar ratio (M:B) of metal (M) to boron (B) in the metal-boron complex may be in a range provided by any two of these upper and/or lower values. In some examples, the molar ratio (M:B) of metal (M) to boron (B) in the metal-boron complex may be in the range of 10:1 (M:B) to 1:10 (M:B), in the range of 5:1 (M:B) to 1:5 (M:B), or in the range of 2.5:1 (M:B) to 1:2.5 (M:B). In one example, the molar ratio (M:B) of metal (M) to boron (B) in the metal-boron complex is in a range of 2:1 to 1:2, for example about 1:1 to 2:1. In some examples where the molar amount of boron is in excess of the metal, further advantages such as metal solubility.

The metallic agent and boron agent can be provided in the coating composition for co-complexing in situ in the composition to provide amounts and molar ratios as described herein, for example each of the metal agent and boron agent provided in an amount of about 0.05 to 2% (based on total wt % of the coating formulation). The metallic agent may comprise zinc, and the co-complexed acid agent may comprise zinc and boron, for example a zinc/boron complexing agent.

### (E) Solvent(s)

The organic polymer, metallic agent, boron agent, metal-boron complex and optional additive may be dissolved or otherwise dispersed in the solvent to obtain the selectively strippable coating composition. The solvent may be a single solvent or a mixture of solvents. Useful solvents include water and/or an organic solvent. Organic solvents can be selected from but not limited to solvents containing groups selected from ketones such as methyl propyl ketone and methyl ethyl ketone; alcohols such an ethanol, isopropanol, tert-butyl alcohol, benzyl alcohol and tetrahydrofurfuryl alcohol; ethers such as glycol ethers, for example di(propylene glycol)dimethyl ether; and/or esters. Small amounts of solvent capable of swelling the coated substrate may be desirable in some applications to enhance adhesion with the layer formed by the selectively strippable coating. Such an example is found in aircraft applications where a primer is pre-coated on a substrate and solvents selected from those containing ketone (e.g. methyl propyl ketone), ether (e.g. dipropylene glycol dimethyl ether) or alcohol (e.g. benzyl alcohol and tetrahydrofurfuryl alcohol) can be added to selectively strippable coating composition. Organic solvents such as ethylene glycol ethers or propylene glycol ether can be added to assist in reducing the surface tension and improving the wetting and film forming. Examples include Dow glycol ethers including Cellosolve™ family solvents (such as ethylene glycol monopropyl ether, ethylene glycol monobutyl ether, ethylene glycol monohexyl ether), Carbitol™ family solvents (diethylene glycol monomethyl ether, diethylene glycol monoethyl ether, diethylene glycol monobutyl ether or diethylene glycol monohexyl ether), Ecosoft™ and Dowanol™ such as propylene glycol propyl ether (PnP), propylene glycol butyl ether (PnB), dipropylene glycol propyl ether (DPnP)dipropylene glycol methyl ether (DPM).

The solvent may be provided in the composition in an amount (based on wt % of composition) of at least about 50, 55, 60, 65, 70, 75, 80, 85, 90, 95, 98, or 99. In an embodiment, the solvent is provided in the composition in an amount (based on wt % of composition) of about 50 to 99, 80, to 98, 85 to 97, or 90 to 95.

The solvent may comprise water, for example the solvent may be provided by an aqueous solvent system comprising water and one or more water-miscible organic solvents. In some embodiments, the water is provided in the composition in an amount (based on wt % of coating formulation) of at least 30, 40, 50, 55, 60, 65, 70, 75, 80, or 85. In some embodiments, water is provided in the composition in an amount (based on wt % of coating formulation) of about 30 to 80, 35 to 75, or 40 to 70.

In some embodiments, the solvent comprises an alcohol. The solvent may be an aqueous solution comprising an alcohol. The aqueous solution may contain water in any amount as described above. The alcohol may be provided in the composition in an amount (based on wt % of formulation) of at least 5, 10, 15, 20, 25, 30, 35, 40, 45, 50, 55 or 60. The alcohol may be provided in the composition in an amount (based on wt % of coating formulation) of less than about 60, 55, 50, 45, 40, 35, 30, 25, 20, 15, 10, or 5. The alcohol may be provided in the coating formulation in an amount range between any two of these upper or lower values. For example, the alcohol may be provided in the composition in an amount (based on wt % of coating formulation) of between 10 and 50, 20 and 45, or 25 and 40. In one embodiment, the alcohol is provided in the composition in an amount (based on wt % of coating formulation) of between 25 and 35. The alcohol may be selected from the group consisting of ethanol, isopropanol, n-propanol, benzyl alcohol, tetrahydrofurfuryl alcohol, and any mixtures thereof. In some examples, the alcohol is isopropanol.

### (F) Optional Organic Crosslinker

The selectively strippable coating and composition as described herein may also include an organic crosslinker. The organic crosslinker may be incorporated into the selectively strippable coating composition prior to application on a coated substrate. Suitable crosslinkers are organic compounds or oligomers comprising of at least two groups capable of reacting with the acid functionalities of the organic polymer. Examples of organic crosslinkers include, but are not limited to aziridine, carbodiimide, epoxy, isocyanate and anhydride.

While not wishing to be bound by any theory, it is believed that the reaction of the organic crosslinker with the carboxylic acid functionalities reinforces the mechanical properties of the selectively strippable coating layer to further improve adhesion. In some embodiments, the organic crosslinker may contain at least two functional groups which may be the same or different and are selected from epoxy, aziridine and anhydride groups. In some embodiments, the crosslinker is carbodiimide. In some embodiments, the crosslinker is polycarbodiimide. In some embodiments, the crosslinker is aziridine. In some embodiments, the crosslinker is polyaziridine.

In some embodiments, the selectively strippable coating composition comprises between 1 and 15 wt % crosslinker (based on the weight of the organic polymer). The crosslinker may be provided in the coating composition in an amount (based on wt % of the composition) of about 2 to 15, 3 to 13, 4 to 12, or 5 to 10. The crosslinker may be provided in the coating composition in an amount (based on wt % of the composition) of at least about 1, 2, 3, 4, 5, 6, 7, 8, 9, 10, 11, 12, 13, or 14. The crosslinker may be provided in the coating composition in an amount (based on wt % of the composition) of less than about 15, 14, 13, 12, 11, 10, 9, 8, 7, 6, 5, 4, 3, or 2. The crosslinker may be provided in the coating composition in an amount range between any two of these upper and lower values.

### (G) Optional Inorganic Fillers

The selectively strippable coatings and compositions described herein may comprise an optional inorganic filler. The inorganic filler is selected from but not limited to silica, alumina oxide, titania oxide, clays such as Montmorillonite, laponite and layered double hydroxide. The particle size of an inorganic filler varies from micro meter to sub micro meter, and in one embodiment can be from 0.5 to 500 nanometre or from 1 to 100 nm. In one example the particle size is from 1 to 50 nm. The loading of inorganic filler may vary depending on the application, for example may be between 0.5 to 70 wt % inorganic fillers, for example between 1 to 50 wt %, between 2 to 40 wt % or between 2 to 30% (based on the weight of dried coating). The inorganic filler may be provided in the coating formulation in an amount (based on wt % of the composition of the formulation) of at least about 0.01 to 15%, for example 0.02% to 10% or 0.05% to 2.5%.

### (H) Optional Wetting Agent

Surface finish is very important for the successful application of decorative coatings, and surface wetting agents can provide further advantages to the selectively strippable coatings or coating compositions, especially when the coating composition is a water-based composition applied on low surface energy or low polarity surfaces. Furthermore, addition of a wetting agent can be useful in industrial application for improved control of drying time and obtaining a broader operation window.

Accordingly, the selectively strippable coating or coating composition as described herein may further include a wetting agent. The wetting agent may be incorporated into the selectively strippable coating composition prior to application on a coated substrate. Suitable wetting agents include, but are not limited to, ethers including glycol ethers (e.g. propylene glycol methyl ether (Dowanol PM) or propylene glycol propyl ether (Dowanol PnP), diprolylene glycol propyl ether (DPnP), propylene glycol butyl ether (PnB), dipropylene glycol butyl ether (DPnB), propylene glycol phenyl ether (PPh)). In some embodiments, the wetting agent is propyl glycol ether. Suitable wetting agents can be obtained from commercial sources, for example, DOW, 3M and BASF.

The wetting agent may be provided in the coating composition in an amount (based on wt % of the formulation) of at least about 0.5, 1, 2, 3, 4, 5, 6, 7, 8, 9, 10 or 15 The wetting agent may be provided in the coating composition in an amount (based on wt % of the composition) of less than about 15, 10, 9, 8, 7, 6, 5, 4, 3, 2, for 0.5. The wetting agent may be provided in the coating composition in an amount range between any two of these upper and lower values. For example, the selectively strippable coating comprises between 0.5% and 5% wt (based on the weight of the coating composition) wetting agent.

### (I) Further Optional Additives

In some embodiments or examples, the selectively strippable coating or coating composition optionally comprises or consists of one or more additives. Suitable additives are known to the person skilled in the art. Examples of such additives include:
(i) rheology modifiers;
(ii) surfactants;
(iii) dispersants;
(iv) anti-foaming agents;
(v) anti-corrosion reagents;
(vi) stabilizers;
(vii) levelling agents;
(viii) film formers and coalescent agents;
(ix) pigments; and
(x) colorants.

It will be appreciated that all the additives are optional and may be added to further enhance application of the coating compositions or further enhance performance characteristics of the completed coating system (e.g. substrate, aged coating, reactivator, final coating). Suitable additives as referred to above are described in further detail as follows to include:
(i) rheology modifiers such as hydroxypropyl methyl cellulose (e.g. Methocell 311), modified urea (e.g. Byk 411, 410), cellulose acetate butyrates (e.g. Eastman™ CAB-551-0.01, CAB-381-0.5, CAB-381-20), and polyhydroxycarboxylic acid amides (e.g. Byk 405);
(ii) surfactants such as fatty acid derivatives (e.g. AkzoNobel, Bermadol SPS 2543), quaternary ammonium salts, ionic and non-ionic surfactants;
(iii) dispersants such as non-ionic surfactants based on primary alcohols (e.g. Merpol 4481, DuPont) and alkylphenol-formaldehyde-bisulfide condensates (e.g. Clariants 1494);
(iv) anti-foaming agents (e.g. BKY®-014, BKY®-1640);
(v) anti-corrosion reagents such as phosphate esters (e.g. ADD APT, Anticor C6), alkylammonium salt of (2-benzothiazolythio), succinic acid (e.g. BASF, Irgacor 153), triazine dithiols, and thiadiazoles;
(vi) stabilizers; such as biocides;
(vii) levelling agents such as fluorocarbon-modified polymers (e.g. EFKA 3777);
(viii) film formers and coalescent agent such as dipropylene glycol dibenzoate (DB);
(ix) pigments, such as those used in aerospace paint compositions, which may include organic phthalocyanine, quinaridone, diketopyrrolopyrrole (DPP), and diarylide derivatives and inorganic oxide pigments (for example to enhance visibility of the reactivation treatment and where it has been applied); and
(x) colorants may be dyes or pigments and include organic and inorganic dyes such as fluorescents (Royale Pigments and Chemicals LLC) (e.g. to enhance visibility of the reactivation treatment and where it has been applied), fluorescein, and phthalocyanines.

In some embodiments, the additives may be selected from rheology modifiers, wetting agents, surfactants, dispersants, anti-foaming agents, levelling agents, colorants and anti-corrosion agents. In some embodiments, the additives may be selected from colorants and anti-corrosion agents. In some embodiments, the additives may be selected from dyes and anti-corrosion agents. In some embodiments, the additives may be selected from UV fluorescent dyes and anti-corrosion agents. In some embodiments, the additives may be UV fluorescent dyes. In some embodiments, the additives may be anti-corrosion agents.

In some embodiments, the compositions and coatings disclosed herein comprise a colorant. The colorant may be a dye or pigment, for example to provide colouration or to see where the activator has been sprayed. The addition of small amount of colorants (for example pigments and dyes) may change the colours of the selectively strippable coating distinguishing from the original substrate and is an useful tool servicing for quality control purpose.

In some embodiments, the colorant may be a dye. Dyes may be organic, soluble in the surrounding medium, and black or chromatic substances. The optional additives may for example be selected from those as described in the book “Coating Additives” by Johan Bielemann, Wiley-VCH, Weinheim, N.Y., 1998. The dyes may include organic and inorganic dyes. The dyes may be organic dyes, such as azo dyes (e.g. monoazo such as arylamide yellow PY73, diazo such as diarylide yellows, azo condensation compounds, azo salts such as barium red, azo metal complexes such as nickel azo yellow PG10, benzimidazone). The dyes may be fluorescents (e.g. Royale Pigment and chemicals, to enhance visibility of the reactivation treatment and where it has been applied), fluorescein, phthalocyanines, porphyrins. In some examples, the colorant may be a UV fluorescent dye. The colorants such as fluorescent dyes could for example be used with UV goggles to look for fluorescence after spraying to insure coverage. It will be appreciated that dyes may be organic soluble for improved compatibility or miscibility with the solvents. Peak absorption may be below about 295 nm, for example, which is the natural cut-on for sunlight. Further examples of fluorescent dyes may include acridine dyes, cyanine dyes, fluorine dyes, oxazine dyes, phenanthridine dyes, and rhodamine dyes.

In some examples, the colorant may be a pigment. Pigments may be in powder or flake-form and can provide colorants which, unlike dyes may be insoluble in the surrounding medium (see “Rompp Lexikon Lacke and Druckfarben”, Georg Thieme Verlag Stuttgart/New York 1998, page 451). Pigments are typically composed of solid particles less than about 1 μm in size to enable them to refract light, for example within light wavelengths of between about 0.4 and 0.7 μm. The pigments may be selected from organic and inorganic pigments including color pigments, effect pigments, magnetically shielding, electrically conductive, anticorrosion, fluorescent and phosphorescent pigments. Further examples of suitable pigments may, for example, be as described in German Patent Application DE-A-2006053776 or EP-AO 692 007. Organic pigments may include may include polycyclic pigments (e.g. phthalocyanide such as copper phthalocyanine, anthraquinones such as dibrom anthanthrone, quinacridones such as quinacridone red PV19, dioxazine such as dioxazine violet PV23, perylene, thionindigo such as tetrachloro), nitro pigments, nitroso pigments, quinoline pigments, and azine pigments. The pigments may be inorganic. The inorganic pigments may be selected from carbon black (e.g. black), titanium dioxide (e.g. white), iron oxides (e.g. yellows, reds, browns, blacks), zinc chromates (e.g. yellows), azurites (e.g. blues), chromium oxides (e.g. greens and blues), cadmium sulphoxides (e.g. greens, yellows, reds), lithopones (e.g. whites). Examples of pigments used in aerospace paint compositions may include organic phthalocyanine, quinaridone, diketopyrrolopyrrole (DPP), and diarylide derivatives and inorganic oxide pigments (for example to enhance visibility of the reactivation treatment and where it has been applied).

In some examples, the compositions and coatings disclosed herein comprise anti-corrosion additives. The anti-corrosion additives may for example facilitate prevention or reduction in corrosion of fasteners (e.g. bare metal or metal alloy based) that might be inserted into or adjacent to coated areas. The use of anti-corrosion additives may provide further advantages for applying coatings containing such fasteners, for example applying a single coating step rather than masking off and pre-preparing the fasteners (conversion coat and primer) prior to coating. Examples of anti-corrosion agents include metal salts including rare earth metals, such as salts of zinc, molybate, and barium (e.g. phosphates, chromates, molybdates, or metaborate of the rare earth metals).

The additive(s) are usually present in an amount of less than about 10% based on the weight of the composition or the organic polymer. For example, the amount of all additives combined, if present, may be provided in an amount of less than about 10%, 9%, 8%, 7%, 6%, 5%, 4%, 3%, 2%, 1%, 0.5%, 0.1%, or 0.05%. The additives may be provided in an amount of greater than about 0.01%, 0.05%, 0.1%, 0.5%, 1%, 2%, 3%, 4%, 5%, 6%, 7%, 8%, or 9%. The amount of all additive(s), if present, may be provided in an amount (based on the total weight of composition) of a range between any two of the above values, for example between about 0.01% and 10%, between about 0.05% and 5%, between about 0.1% and about 3%, or between about 0.5% and 2%.

The reference to “substantially free” generally refers to the absence of a compound in the composition other than any trace amounts or impurities that may be present, for example this may be an amount by weight % in the total composition of less than about 1%, 0.1%, 0.01%, 0.001%, or 0.0001%. The compositions as described herein may also include, for example, impurities in an amount by weight % in the total composition of less than about 5%, 4%, 3%, 2%, 1%, 0.5%, 0.1%, 0.01%, 0.001%, or 0.0001%. In some examples, the compositions and coatings described herein are substantially free of surfactants. In some examples the compositions and coatings defined herein do not contain surfactants.

As further described below in relation to the process conditions for application, in at least some examples the present coating compositions are configured to provide a minimum film forming temperature (MFT) for ambient conditions. For example, the MFT of various coating compositions may be provided at about 0 to 40° C., 5 to 35° C., 10 to 30° C., 15 to 25° C., or about 20° C.

Processes for Application and Removal of Coatings

The selectively strippable coating composition as described herein can be applied onto a coated substrate to form a selectively strippable coating layer by any method known in the coating industry including spray, drip, dip, roller, brush or curtain coating, especially spray. Accordingly, the present disclosure also relates to a selectively strippable coating which when present on a coated substrate, prior to at least one post coating layer, enables the selective removal of the post coating layer from the coated substrate by removal (e.g. stripping) while preserving the integrity of the coated substrate (including underlying coating present on the substrate). The selectively strippable coating can be formed from the selectively strippable coating composition described herein. The terms “selectively strippable coating” and “selectively strippable coating layer” are used interchangeably.

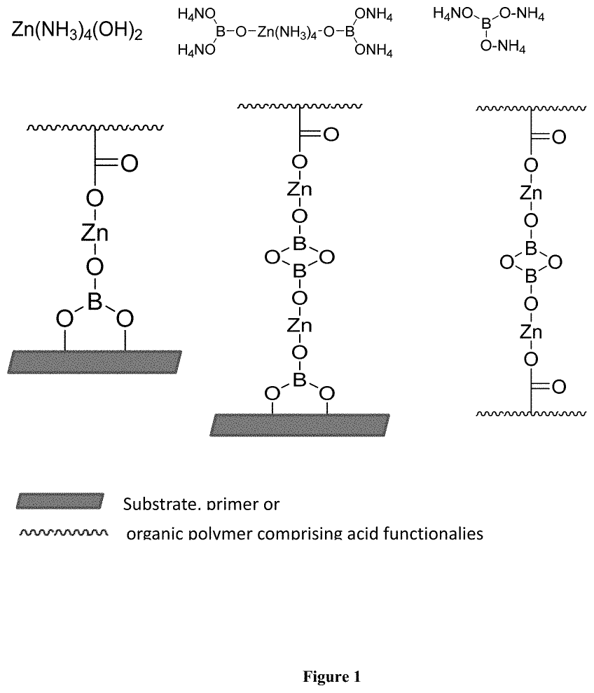

In some embodiments, there is provided a selectively strippable coating comprising or consisting of a) an organic polymer comprising carboxylic acid functionalities, b) a metallic agent, and c) a boron agent, and optionally one or more of d) to i) as previously described. In another example, the selectively strippable coating comprises or consists of (a) one or more organic polymers comprising carboxylic functionalities, (b) a metal-boron complex or salt, and optionally one or more of d) to i) as previously described. Component (a) may be provided by an organic film former according to any examples as described herein. It will be appreciated that components e) to i) relate to components in the coating formulation prior to curing and adhesion on the coated substrate, and therefore any one or more of those components may not be present in the coating layer (e.g. after curing and drying), or if present may be in residual amounts. The metallic agent and boron agent can form a coordination complex with at least one acid functionality of the organic polymer. Without wishing to be bound by any theory it is believed that at least one acid functionality, metallic agent, and boron agent form a coordination complex creating reversible crosslinks between multiple polymer chains, the polymer and coated substrate and/or the polymer and topcoat (for example, see FIG. 1). Furthermore, it is believed that during the stripping process, for example with an alkaline stripper, the stripping agent effectively reverses the crosslinking process, disassembling or disrupting at least part of the coordination complex, to enable stripping of the selectively strippable coating layer and any associated topcoat while preserving the integrity of any underlying coating and substrate.

As would be understood by a person skilled in the art, depending on volatility the components previously described in relation to the selectively strippable coating composition also apply to the selectively strippable coating layer, at least according to some embodiments and examples as described herein.

For example, the embodiments or examples of each of the organic polymer, metallic agent and boron agent, as previously described in relation to the selectively strippable coating composition may apply equally to the selectively strippable coating layer. The selectively strippable coatings may also comprise the optional components defined herein for the coating compositions or residuals of the optional components from the coating compositions such as but not limited to the wetting agents, film forming and de-foaming agent, surfactants, dispersing agents, pigments, dyes and colorants.

The dry thickness of the selectively strippable coating depends on the application. In some embodiments, the dry thickness of the selectively strippable coating layer (in microns) is less than about 15, 14, 13, 12, 11, 10, 9, 8, 7, 6, 5, 4, 3, 2, or 1. The dry thickness of the selectively strippable coating layer may be in a range between any two of these previous values. In some embodiments, the dry thickness of the selectively strippable coating layer is between about 0.1 to 10 microns. In some embodiments, the dry thickness of the selectively strippable coating layer is between about 0.5 to 5 microns. One advantage of the selectively strippable coatings of the present disclosure, at least according to some embodiments or examples as described herein, is that they can be applied at a dry thickness (e.g. consistent thinness) that does not add significant weight in the context of the whole coating system.

The selectively strippable coating layer provides effective in-service adhesion between the coated substrate and any post coating layers on the strippable coating layer, while allowing for a future maintenance (e.g. stripping) process to be used to remove the post coating layers from the coated substrate at a later desired service time point. Any suitable method known to those skilled in the art may be used to assess whether the adhesive linkage between the strippable coating layer and other layers (e.g. coated substrate or post coating layer). Methods may include but are not limited to ASTM, ISO, and FAA standards, in-house test methods to simulate in-service performance, in-service performance itself, and durability testing either actual or accelerated. For the case of aerospace coatings, test methods based on water impact, such as whirling arm rain erosion and the Single Impact Jet Apparatus (SIJA) (MIJA Limited, Cambridge, UK), have been found to be useful for assessing inter-coat adhesion. In these cases, the amount of overcoat removal is related to the level of inter-coat adhesion.

In some examples, the present disclosure provides a method or use of the coating compositions, or coatings thereof, as adhesion promoting interlayers for use in promoting adhesion between layers of a coated substrate, for example as an intermediate or intercoating (IC) layer for a coated composite.

The selectively strippable coating of at least some embodiments or examples as described herein can provide an effective means of selectively stripping an aged coating such as a polyurethane overcoat from a coated composite or conversion coated aluminium substrate. The selectively strippable coating of at least some embodiments or examples as described herein can provide one or more advantageous properties desirable for aerospace coating systems such as desired levels of chemical resistance (e.g. to hydraulic fluids, aviation fuels and cleaners), environmental durability, and/or mechanical properties.

In some embodiments or examples as described herein, the selectively strippable coatings can provide a broad application and/or cure window. According to at least some embodiments or examples, the selectively strippable coating compositions can be effectively applied to coated substrates with an application window for temperatures ranging from 15° C. to 35° C. and relative humidity ranging from 10% to 85%. In some embodiments or examples, the selectively strippable coating can provide flexible application, post coating or stripping timeframes. Further details on the application and cure windows, and operational and processing efficiencies are described in further detail below.

### Coating System

In some embodiments, the selectively strippable coating layer may form part of a coating system. As used herein, a “coating system” is defined broadly and in some embodiments comprises (i) a coated substrate (e.g. polymer coated composite); (ii) at least one post coating layer; and a selectively strippable coating layer located between (i) and (ii).

The location of the selectively strippable coating in the coating system is not limited, for example the selectively strippable coating composition can be applied onto a protective layer (such as the primer, undercoat, conversion, anti-corrosion layers) of the substrate as an intercoating (IC) layer in between any layer of the coating system prior to any final post coating. For example, the coating composition may be applied to the primer prior to the application of any further post coating layers such as decorative or functional topcoat layers; or otherwise applied on the surfacing film or conversion coatings prior to the application of the post coating layers.

### Substrate

Suitable substrates include metals and metal alloys (e.g. aluminium), composites (e.g. carbon fiber or glass fiber reinforced epoxy) and other substrates comprised of polymers (e.g. polyimide), and elastomers (e.g. polysulfide sealants).

The substrate to which the selectively strippable coating can be applied is a coated substrate. The reference herein to “coated substrate” refers to a previously coated substrate, such as a substrate previously coated with a protective layer selected from one or more of a primer, undercoat, conversion, and anti-corrosion layer. In other words, the reference to “coated substrate” generally refers to a substrate that has a protective coating, for example a composite comprising a primer coating or a metal comprising a conversion coating. The strippable coating can then be applied to the “coated substrate” and then post coating layers applied over the strippable coating. In one example, the substrate is a conversion coated metallic substrate, epoxy composite or polymer composite coated substrate, for example on substrates where a protective layer has been applied. In other words, the selectively strippable composition is applied to, or selectively strippable coating provided on, a coated substrate.

As used herein, “protective coating” or “protective layer” is defined broadly and includes anti-corrosion coatings, conversion coatings, surfacing films, under coats and/or primers. For aircraft applications, metallic substrates are typically coated with a conversion coating before the selectively strippable coating is applied. Any suitable conversion coating may be used, for example, Boegel or Ridoline. For aircraft applications, composite substrates are typically coated with a primer layer and/or surfacing film. Any suitable primer may be used. For example, epoxy based primers. For a polymer based substrate, further advantages can be provided by surface activation by physical, physiochemical or chemical oxidation or by application of the primer, prior to application of the selectively strippable coating composition.

It will be appreciated that the substrate (or coated substrate) may be configured to form part of an article, object or device, for example a component that can be further processed or assembled into a transportable product. The substrate may be a support structure, such as a panel constructed for use as a structural support section in a building, vehicle or aircraft. In some examples, the substrate may be components of a spar, rib, former, longeron, stringer, skin, wing, fuselage, empennage, control surface, and/or other structure of an aerospace vehicle. In some examples, the substrate may be components of a chain or turbine, such as a wind turbine. In some examples, the substrate may be automobile components. The substrate may comprise or consist essentially of a metal, metal alloy and/or composite material. The metal or metal alloys may be aluminium, titanium, or alloys thereof. The composite material may be carbon fiber reinforced epoxy or glass reinforced epoxy materials. The composite materials may contain glass, wood or fabric. The coated substrate may be a conversion coated metal or a primer coated composite material. The coated substrate may be a substantially inelastic or rigid plastic, which may include polyimides or polycarbonates.

The coated substrate may be a substrate according to any examples as described herein comprising a coating selected from one or more of a polyurethane, polyamide, polyether, polyester, polyolefin, co-polymers thereof, and blends thereof. For example, the coated substrate may be a composite material structure comprising a coating selected from one or more a polyurethane, polyamide, polyether, polyester, polyolefin, co-polymers thereof, and blends thereof.

### Post Coating Layer

The one or more post coating layer(s) that can be applied on the selectively strippable coating layer include, but are not limited to, fully or partially cross-linked organic coatings. Examples of organic coatings include, polyurethane, epoxy, polyester, polycarbonate and/or acrylic coatings. In an embodiment, the organic coating applied after the selectively strippable coating is a polyurethane or epoxy coating. Due to their superior mechanical properties and resistance to abrasion, chemical attack and environmental degradation, such organic coatings are widely used to protect infrastructure in the aerospace, marine, military, automotive and construction industries. The coating may be a solvent based coating or a powder coating, and may be applied by any means known to those in the art including spray, drip, roller or brush. Electrostatic painting may be applied in the solvent based system and electrostatic powder coating is applicable with solvent free powder coating systems.

### Process for Preparing and Applying Coatings

A process for preparing a coating system as described herein can comprise:

applying a selectively strippable coating composition to a coated substrate to form a selectively strippable coating; and

applying at least one post coating layer to the selectively strippable coating present on the coated substrate.

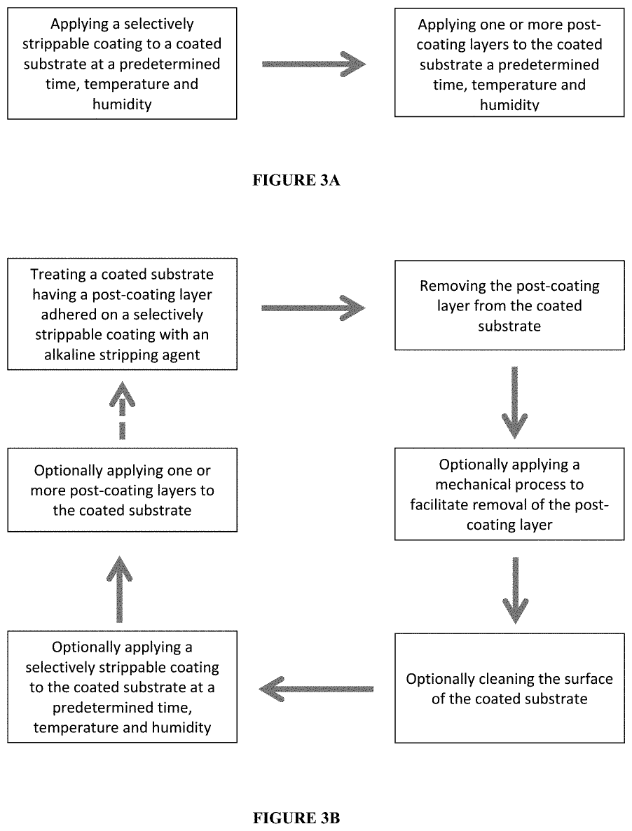

The process may comprise any one or more of the embodiments or examples as described herein in relation to the selectively strippable coating composition, coated substrate, post coating layer(s), coating(s), or other application processes as described herein. FIG. 3a refers to a process for applying the selectively strippable coating to a coated substrate.

In one example, the process for preparing a coating system may comprise:

applying the selectively strippable coating composition to a coated substrate within a first predetermined time, temperature and humidity; and

applying at least one post coating layer to the selectively strippable coating present on the coated substrate within a second predetermined time, temperature and humidity.

It will be appreciated that the predetermined time, temperature and humidity, for application of the selectively strippable coating composition and any one or more post coating layers, including the above first and/or second predetermined time, temperature and humidity, may be provided according to any of the embodiments or examples as described herein.

The substrate can be a coated substrate according to any embodiments or examples as described herein.

In one example, the process for preparing a coating system comprises:

applying the selectively strippable coating composition to a conversion coated metal or metal alloy; and

applying at least one post coating layer to the selectively strippable coating present on the conversion coated metal or metal alloy.

In another example, the process for preparing a coating system comprises:

applying the selectively strippable coating composition to a composite; and

applying the at least one post coating layer to the selectively strippable coating present on the composite.

It will be appreciated that the coated substrate including conversion coated metal, conversion coated metal alloy, or composite, may be provided according to any of the embodiments or examples as described herein.

The coated substrate including conversion coated metal, conversion coated metal alloy, or composite, may be a support structure, such as a panel, for example an aircraft panel. The coated substrate may form part of, or be configured to form part of, a building, vehicle or aircraft. For example, the coated substrate may be a complete building structure, vehicle or aircraft component or section, such as an aircraft nose, wing or tail section, or for example an entire aircraft.

The coating compositions may therefore be applied to small or large area, to sections of larger parts, components or full infrastructure such as infrastructure associated with the aerospace (e.g. aircraft), automotive (e.g. vehicles), marine (e.g. ships), transportation (e.g. trains), military (e.g. helicopter, missile) or construction industries (e.g. buildings, factories, floors). The surface may have simple or complex geometry or may be at any orientation. Treatment may be conducted once or multiple times prior to interaction with the further coating and/or other entities.

As previously described, the coating compositions may be a liquid formulation effective for application as a spray, brush, dip, knife, blade, hose, roller, wipe, curtain, flood, flow, mist, pipette, aerosol or combinations thereof. In one example, the application is a water based liquid spray formulation.

The coating compositions according to at least some embodiments and examples as described herein can provide for an improved application window, for example at least one of time, temperature and humidity, such as when, in use, applying and curing strippable coatings located between a coated substrate and further post coat layer(s). The application window can involve various environmental conditions where the strippable coating can be applied to a substrate (e.g. conversion coated metal or primer coated composite material) and any further coatings adhered thereto, such that its adhesion meets in-service performance requirements. For example, the application window may involve a duration of time following curing of the coating present on the coated substrate such that adherence of a further coating would meet performance requirements. The strippable coating then provides an in-service coating with the capability of being more readily stripped under an effective removal window.

The process or method of application of the selectively strippable coating compositions may be conducted at ambient temperatures, for example ranging from about 10 to 35° C. The process or method of application may also be conducted generally around typical atmospheric pressures (e.g. between about 90 and 105 kPa, and more typically about 101 kPa). The application window may occur at ambient temperature. For example, ambient temperature may be between 15 and 30° C. or 18 to 30° C. Application of the coating compositions may not require any pre-heating of the existing coated substrate. Heat curing of the coating composition or further re-application thereof may not be required, although heat curing may be provided depending on any further advantages that might be obtained from the development of chemical and physical bulk properties in the coating.

One advantage of the selectively strippable coating compositions is that they can be applied and cured across a relatively broad application window (e.g. combination of broad parameters of temperature, pressure and humidity), and in particular across a broad humidity range. Pressure differences will typically relate to natural range of atmospheric pressures across different regions or countries around the world.

The application window may, for example, be at a relative humidity of less than about 90%, 80%, 70%, 60%, 50%, 40%, 30%, 20%, 18%, 16%, 14%, 12%, 10%, 8%, 6%, 4%, or 2%. The application window may be at a relative humidity of greater than about 2%, 4%, 6%, 8%, 10%, 12%, 14%, 16%, 18%, 20%, 30%, 40%, 50%, 60%, 70%, 80% or 90%. The application window may be at a relative humidity of between any two of these values, for example between about 1% and 90%, 5% and 85%, 10% and 70%. It will be appreciated that the relative humidity for a given partial water vapor pressure depends on temperature. The partial water vapor pressure and temperature are independent variables and relative humidity (RH) is a dependent variable although there is a constraint that the relative humidity cannot exceed 100% at any particular temperature. For example, any one or more of the above relative humidity values may be provided where the temperature is between about 10 to 35° C., between about 15 and 30° C., or between about 18 to 30° C. The above relative humidity values may for example be where the temperature is at value of about 15° C., 16° C., 17° C., 18° C., 19° C., 20° C., 21° C., 22° C., 23° C., 24° C., 25° C., 26° C., 27° C., 28° C., 29° C., or 30° C. The application window may be any combination of the above RH and temperature ranges or values. For example, the application window may be where the RH is between about 10% and 75% and a temperature range between about 15° C. and 30° C. The application window may for example be at least about 10% RH at a temperature between about 15° C. and 30° C. The application window may for example be less than about 70% RH at a temperature between about 18° C. and 30° C.

The coating composition may contain optional additives, for example to modify the drying time, or reduce corrosion. Such additives have been previously described herein and include but are not limited to anticorrosion additives and colorants such as dyes and pigments. The additive may be a colorant such as a dye, for example a UV fluorescent dye to indicate where the coating composition has been applied. It will be appreciated that these additives are optional and are not essential to the coating composition. For example, the additives, if present, do not necessarily contribute to adhesion and removal properties. The optional additives are described in further detail as previously above.

Any suitable method known to those skilled in the art may be used to assess whether the adhesive linkages between the coating compositions, substrate and further coatings are fit for purpose. Such tests include but are not limited to ASTM, ISO, or SAE standards, in-house test methods to simulate in-service performance, in-service performance itself, and durability testing either actual or accelerated. In the case of aerospace coatings, test methods based on water impact, such as whirling arm rain erosion and the Single Impact Jet Apparatus (SIJA) (MIJA Limited, Cambridge, UK) have been used, and whirling arm rain erosion has been found to be particularly useful for assessing intercoat adhesion for aerospace coatings. In these cases, the degree of coating removal is related to the level of intercoat adhesion and simulates the effect of rain erosion observed on commercial airplanes. Typically, these two tests provide more differentiation in adhesive linkages for aerospace coatings than other test methods. These methods have been described in the reference, Berry D. H., and Seebergh J. E., “Adhesion Test Measurement Comparison for Exterior Decorative Aerospace Coatings: Two Case Studies”, Proceedings 26th Annual Adhesion Society Meeting, Myrtle Beach, S.C., pp 228-230 (2003).

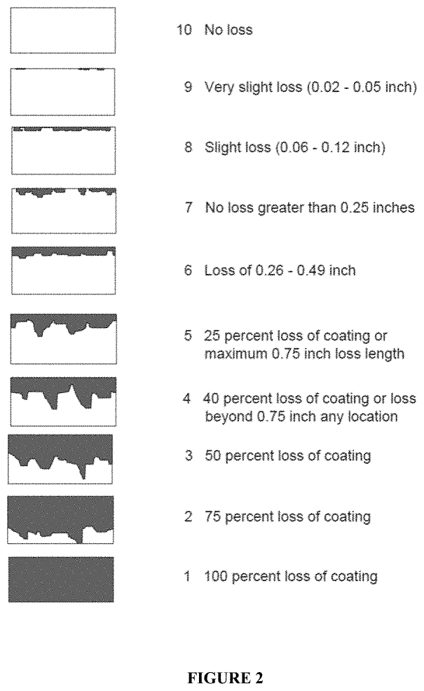

For rain erosion testing, % area removal of an overcoat can be used to determine the degree of intercoat adhesion between overcoat and underlying coating, and this can be quantified by image analysis including visual inspection or measurement. For example, the length of the longest tear, or alternatively, % of area removed is measured. FIG. 2 provides a visual representation relating to a scale of 1 to 10 corresponding to % area of coating removed under testing, such as rain erosion testing. For example, a level 6 scale value is equivalent to about less than 15% area removed, a level 7 is less than about 10%, a level 8 is less than about 5%, and a level 9 is less than about 1%. The coating compositions or coatings thereof of the present disclosure according to at least some embodiments or examples may provide a scale rating of 10, 9, 8, 7, 6, 5, 4, 3, or 2, when measured by Single Impact Jet Apparatus or Rain Erosion Testing as described herein. In one example, the scale rating for the present coating compositions or coatings is at least 6 when measured by Single Impact Jet Apparatus or Rain Erosion Testing as described herein.

Single Impact Jet Apparatus (MIJA Limited, Cambridge, UK)) testing may be with equipment configured using a 0.8 mm nozzle and 0.22 calibre 5.5 mm Crosman Accupell Pointed Pellets (#11246). Testing can involve immersion in water for about 16 to 18 hours and using a 45° specimen to impact droplet geometry. A single water jet can be used with impact velocity of about 600+25 m/s.

Rain erosion testing can use a whirling arm rain erosion apparatus employing a 1.32 m (52 inch) zero lift helicopter like propeller run at 3600 rpm. Post coats (e.g. coating on the selectively strippable coating) can be applied at 80 to 120 microns of paint thickness with masking to produce a leading edge. A velocity of about 170 ms⁻¹ can be provided at the midpoint of a testing sample. An effective rain field density can be about 2 mm droplets corresponding to about 2.54×10⁻⁵ kmh⁻¹ (1 inch per hour). The impact of rain erosion can be determined after 30 minutes testing and the inter-coat adhesion of the samples evaluated according to the amount of paint removed or tear lengths as described above.

### Post Coating Layer Removal

Selective stripping of post coating layers can be achieved using any suitable known stripping technique such as application of a paint stripper formulated with an organic solvent or a mixture of organic solvents with water. While not wishing to be bound by any theory, it is anticipated that stripping of the post coating layers occurs by disruption of coordinate bonds between the organic polymer and the metal/non-metal co-complexing structure present in the selectively strippable layer. Suitable paint strippers include commercially available strippers based on aqueous benzyl alcohol with activating additives having alkaline, acid or peroxide group(s). In one embodiment, the stripper is an alkaline based stripper and selectively strippable coating composition and coating is an alkaline strippable coating composition or coating. For example, the paint stripper may be an alkaline stripper, such as a benzyl alcohol based stripper. One example of a benzyl alcohol based alkaline stripper is CeeBee® paint stripper E-2002A, CeeBee® E-2787 or CeeBee® E-2012 from McGean-Rohco Inc, Bonderite® S-ST1270-6 AERO from Henkel. Addition of a base chelating agent to the alkaline paint stripper may be desirable to further accelerate the stripping.

Alkaline-based benzyl alcohol paint strippers can provide further advantages because this class of strippers is more benign to the primer and the underlying substrate that is being protected by the primer. Stripping removes the selectively strippable coating while maintaining the integrity of the coated substrate including underlying substrate. The selectively strippable coating may be stripped away from the coated substrate in a limited amount of time, such as less than 36 hours, 24 hours, or 12 hours, so that the stripper does not reach and adversely impact on the surface of the substrate through a primer coated on the substrate, for example where particular substrates may be adversely impacted by particular stripping agents. In some examples, the coating compositions and coatings can provide a stripping window of less than about 36 hours, or less that about 24 hours, in accordance with the methods as described herein.

Mechanical means can also be applied to facilitate the post coat stripping at the final stage of the stripping process including high pressure water jet and touch up sanding. High pressure water jet is commonly applied in aerospace industries at the final stage when the post coating layer is disrupted and loosely attached on the surface to remove off the post coating layer.

Once the post coating layers are selectively removed, the selectively strippable coating can be re-formed or re-applied prior to re-application of a new post coating layer for future selective removal. Generally a post surface cleaning with water base cleaner or solvent wiping is applied to the freshly stripped substrate and in aerospace industries a base water cleaner is usually used to clean the surface prior application of the selectively strippable layer. A further advantage according to at least some embodiments or examples of the present disclosure is that the stripping or removal of the selectively strippable coatings may not require cleaning process with organic solvent after stripping.

In view of the above, a process for selectively removing a post coating layer from the coating system according to any aspects, embodiments or examples as described herein may comprise:

a) treating the post coating layer(s) with a stripping agent capable of disrupting the selectively strippable coating; and

b) removing the post coating layer(s) from the coated substrate.

The process for selectively removing a post coating layer from the coating system according to any embodiments or examples as described herein may comprise:

a) treating the post coating layer(s) with an alkaline stripping agent capable of disrupting the selectively strippable coating; and

b) removing the post coating layer(s) from the coated substrate.

The process may comprise any one or more of the embodiments or examples as described herein in relation to the selectively strippable coating, substrate, post coating layer(s), or removal/stripping processes.

In one example, the process for selectively removing a post coating layer from the coating system may comprise:

a) treating the post coating layer(s) with an alkaline stripping agent capable of disrupting the selectively strippable coating within a first predetermined time, temperature and humidity; and

b) removing the post coating layer(s) from the coated substrate within a second predetermined time, temperature and humidity.

It will be appreciated that the predetermined time, temperature and humidity, for the process, including the above first and/or second predetermined time, temperature and humidity, may be provided according to any of the embodiments or examples as described herein. The temperature and humidity may be substantially similar for steps a) and b).

The process for selectively removing a post coating layer from the coating system according to any embodiments or examples as described herein where the coated substrate is a conversion coated metal or metal alloy may comprise:

a) treating the post coating layer(s) with an alkaline stripping agent capable of disrupting the selectively strippable coating; and

b) removing the post coating layer(s) from the conversion coated metal or metal alloy.

The process for selectively removing a post coating layer from the coating system according to any embodiments or examples as described herein where the coated substrate is a composite material may comprise:

a) treating the post coating layer(s) with an alkaline stripping agent capable of disrupting the selectively strippable coating; and

b) removing the post coating layer(s) from the composite material.

It will be appreciated that the coated substrate including conversion coated metal, conversion coated metal alloy, or composite, may be provided according to any of the examples as described herein.

The coated substrate including conversion coated metal, conversion coated metal alloy, or composite, may be a support structure, such as a panel, for example an aircraft panel, or a complete building structure, vehicle or aircraft, according to any embodiments or examples as previously described herein.

It will be appreciated that the alkaline based stripper, solvents, or optional additives, for the stripping and removal process may be provided according to any of the examples as described herein. For example, the alkaline based stripper may be an aqueous alkaline based stripper comprising one or more organic solvents (e.g. alcohol solvents such as benzyl alcohol) and optionally one or more additives (e.g. base chelating agents).

Other optional process steps following the treatment with the stripping agent may include mechanical processes such as water jet treatment, which can be provided as additional optional steps to further facilitate removal of any post coating layers. Other optional process steps may include surface cleaning (e.g. wiping with solvents). However, one advantage of the present selectively strippable coating is that at least according to some embodiments or examples, an organic solvent cleaning step is not required prior to re-application of a selectively strippable coating and any post coating layers to the substrate.

In another example, the process for selectively removing a post coating layer from the coating system according to any embodiments or examples as described herein may comprise:

a) treating the post coating layer(s) with an alkaline stripping agent capable of disrupting the selectively strippable coating;

b) removing the post coating layer(s) from the coated substrate and optionally applying a mechanical process for facilitating the removal of the post coating layer(s);

c) optionally cleaning the surface of the coated substrate;

d) optionally applying a selectively strippable coating composition and any post-coating layers according to any one or more embodiments or examples of the above application process as described herein.

A process for selectively removing a post coating layer from the coating system is shown in FIG. 3b. It will be appreciated that the process can comprise application of a fresh coating system to the coated substrate following removal of the previous post coating layers.

Many modifications of examples set forth herein will come to mind to one skilled in the art to which the present disclosure pertains having the benefit of the teachings presented in the foregoing descriptions and the associated drawings and figures. Therefore, it is to be understood that the present disclosure is not to be limited to the specific examples illustrated and that modifications and other examples are intended to be included within the scope of the appended claims. Moreover, although the foregoing description and the associated drawings and figures describe examples of the present disclosure in the context of certain illustrative combinations of elements and/or functions, it should be appreciated that different combinations of elements and/or functions may be provided by alternative implementations without departing from the scope of the appended claims.

### EXAMPLES

The present disclosure will now be described with reference to the following non-limiting examples and with reference to the accompanying figures.

### Materials and Methods

### Coated Substrate and Pre-Treatment

The examples were completed on Al alloy and epoxy-carbon fibre composite panels (also referred to herein as Al or composite coupons). These composite coupons were pre cleaned with alkali cleaning agents and air dried before wiping with methyl propyl ketone and drying at the room temp. prior to primer and coating applications. Al coupons were scribed with 3M soaked with alkaline solution (Pace B82), rinsed with water and treated with conversion coating (Boegel), dried in air and applied with primer within application window from 30 minutes to 7 days.

### Primer, Coatings and Painting Conditions

Primer (Desoprime® CA 7501 Non-Chromated HS FR Primer Gray), intermediate coat (F565-4010), and top coat (Desothane® HS CA8000/B70846X) were all purchased from PPG and prepared and applied as per specifications. Aerodur® base coat and clear coat were obtained from Akzonobel and applied as per specification.

Spray painting of the composite coupons occurred in two stages, or three stages if an assembly coating was applied. In the two stage case, PPGCA7501 primer was applied to the coupon within 24 hours of pretreatment at a target dry film thickness (DFT) of 20 micron (within range of 18 to 25 micron) and cured (typically at 70 F 40% RH). A continuous film of PPG Industries Inc CA8000 topcoat (C thinner) was then applied (70100 micron) within 24 hours of samples being primed and within 3 hours post surface treatment, on applicable samples (unless otherwise specified) or otherwise Aerodur® basecoat/clearcoat were applied (from 75 to 125 micron). In the three stage case, PPG CA8000 topcoat was applied on the substrate at a target DFT of 25 micron (assembly coating) and cured (typically at 70 F 40% RH) overnight before the over coat Aerodur® basecoat/clear coat were applied. Surface activation of the assembly coating with Zip Chem® Sur-Prep AP-1 can be applied to the assembly coating prior to application of Aerodur® Basecoat/Clear coat if desired.

If used, the selectively strippable coating layer was formed by applying the coating composition to the coupon after the primer was sprayed and cured. The coating composition was typically applied between 2 to 24 hours after application of the primer.

A Yamaha robotic painting arm incorporating a gravity-fed Binks Mach® 1A automatic spray gun, configured with a 94 nozzle was employed in spray painting of flat panels. Spray painting was conducted with an inlet pressure of 40 psi, a scan rate of 100 mm/s and a specimen to gun nozzle distance of 180 mm. The coating thickness was controlled by the gun's fluid needle control position adjusted in line with paint thickness measurements assessed using a Fischer Isoscope (MPOD) on aluminium substrates.

Samples prepared for SIJA analysis were taped in the middle of the coupon with ½″ 3M vinyl tape (#471) before topcoat application to generate a leading paint edge upon its removal.

### Application

Application of the coating composition was conducted using a Binks Mach® 1A automatic spray gun, configured with a 97P nozzle. A 40 psi inlet pressure was utilized during application. Spray of treatment formulation was done similar to other coatings. Samples were allowed to dry for 1-3 hours before application of over coatings (such as Desothane® top coat or Aerodur® base coat/clear coat).

### Coating Compositions

### A: Organic Polymers Comprising Acid Functionalities

A1: Polyurethane comprising carboxylic acid functionalities was tested in various formulations. Polyurethane dispersion Dispurez® 101 (PU-D101) containing about 5 wt % carboxylic acid was purchased from Incorez UK and used as received. PU-D101 is a waterborne aliphatic polycarbonate polyurethane dispersion containing approximately 31% solids content. Another carboxylic acid containing polyurethane was also tested, which was a dispersion made by the process described by Dieterich. (D. Dieterich, Aqueous emulsions, dispersions and solutions of polyurethanes: synthesis and properties. Progress in Organic Coatings, 9 (1981), 281-340.) Diols, diisocyanate, catalyst and chain extender were dissolved in MEK at 80° C. and stirred for several hours until NCO disappeared. PU containing carboxylic acid groups were synthesized from HMDI (diisocyanate), Oxyymer M112 (diol), DMBA (acid diol), MEK (solvent), Dibutyltin dilaurate (DBTDL, catalyst) and ethylenediamine (EDA) or Butanediol (BD) chain extender. PU containing carboxylic acid content 10%, 12.5% 15% and 18% (DMBA by weight) were obtained. 25% PU water dispersion was coded as PU-EDA100 and PU-EDA125 for PU with EDA as a chain extender, PU-BD-150 and PU-BD180 for PU with BD as chain extender.

A2: Polyolefin comprising carboxylic acid functionalities was tested in various formulations. The polyolefins tested were polyethylene co-acrylic copolymers (PEAA), which were obtained as a solid resin from Dow (Primacor® 5990I with 20 wt % acrylic acid, and Primacor® 5980I with 20.5 wt. % acrylic acid content). The PEAA resin was dissolved in ammonia water solution. Typically 40 g PEAA was added to a 500 mL round bottom flask and 8 g of 25% ammonia solution and 152 g of water were added. The resulting suspension, consisting of 20 wt. % PEAA, was stirred at reflux until all PEAA is fully dissolved. Alternatively, the PEAA dispersion can also be obtained commercially from Michem (Michem® Prime 4983R, 24.2-25.4% non-volatile content).

### B: Metallic Agent/Borate Solution

Zinc oxide (99.5%) was purchased from Chem-Supply. Boric acid was obtained from Sigma-Aldrich Australia. The metallic/borate solution was prepared by dissolving ZnO in boric acid and ammonia solution with the amount of Zn/B adjusted to the ratio required. For example, 5 g ZnO was dissolved in 95 grams solution containing 10% ammonia solution at room temperature to obtain 5% ZnO/borate ammonia solution, with mole ratio of Zn:B being approximately 1:1. The concentration of the solution may be adjusted to obtain fully soluble ZnO/borate solution (referred here after as ZnO/BA solution).

### C: Additive

Co-solvent and wetting agent at the desired weight ratio were pre mixed and added to the formulation. For example, 100 g benzyl alcohol was mixed with 100 g propylene glycol propyl ethyl (PnP) to get a 1:1 mixture or 25 g propylene glycol propyl ether (PnP), 20 g propylene glycol butyl ether (PnB) and 25 g propylene glycol phenyl ether (PPh) were mixed to make a PnP/PnB/PPh (5:4:5) additive, or 25 g PnB was mixed with 25 dipropylene glycol butyl ether (DPnB) to make a PnB/DPnB additive, or 22.5 g PnB, 22.5 g DPnB and 5 g dipropylene glycol dibenzoate to make a PnB/DPnB/DB additive.

### Preparation of the Coating Composition

Components Al (e.g. PU-D101) were diluted with water to the desired concentration, before optional component A2 (PEAA dispersion) was added and the resulting polymer dispersion mixed well. Component B (ZnO/BA solution) with desired Zn/B ratio was added to the polymer dispersion before isopropanol, co-solvent and wetting agent and other optional additives were then added in slowly with stirring, to obtain final treatment formulation.

### Formulations

Various formulations of the coating compositions were prepared (see below Table 1), which include formulations of the following Examples. In Table 1, the below terms have been used:

PEEA: Polyethylene acrylic acid;

PU-D101: Polyurethane D101;

ZnO: Zinc oxide;

BA: Boric acid;

PnP: Propylene glycol propyl ether;

PnB: Propylene glycol butyl ether;

BnA: Benzyl alcohol;

PPh: Propylene glycol phenyl ether;

DPnB: Dipropylene glycol butyl ether;

DB: Dipropylene glycol dibenzoate;

IPA: Isopropanol; and

MEK: Methyl ethyl ketone.

TABLE 1
Formulations

| | | | | | | | |
|---|---|---|---|---|---|---|---|
| | | Organic Polymer | | | | | |
| | % Organic | Ratio: | % | Ratio | | Co-Solvent | |
| Code | Polymer | PU-D101:PEAA | ZnO:BA | Zn:B | Filler | % PnP | Other Additives |

PU-D101 and Primacor ® 5990I (P5990)

| | | | | | | | |
|---|---|---|---|---|---|---|---|
| F1 | 7.5 | 8:2 | 0.35% | 2:3 | 0 | 0 | 5% PnB:BA (1:1) |
| F2 | 8.5 | 8:2 | 0.35% | 2:3 | 0 | 0 | 5% PnB:BnA (1:1) |
| F5 | 10 | 8:2 | 0.35% | 2:2 | 0 | 0 | 5% PnB:BnA (1:1) |
| F6 | 7.5% | 8:2 | 0.35% | 2:2 | 0 | 2.5% | 5% PnB:PPh (1:1) |
| F7 | 7.5% | 85:15 | 0.30% | 2:2 | 0 | 2.5% | 5% PnB:PPh (1:1) |
| F8 | 7.5% | 9:1 | 0.25% | 2:2 | 0 | 2.5% | 5% PnB:PPh (1:1) |
| F9 | 7.5% | 8:2 | 0.35% | 2:2 | 1.5% | 2.5% | 5% PnB:DPnB (1:1) |
| | | | | | silica | | |
| F10 | 7.5% | 9:1 | 0.25% | 2:2 | 1.5% | 2.5% | 5% PnB:DPnB (1:1) |
| | | | | | silica | | |
| F11 | 7.5% | 8:2 | 0.33% | 2:2 | 0 | 5% | 5% PnB:DPnB (1:1) |

PU-D101 and Primacor ® 5980I (P5980)

| | | | | | | | |
|---|---|---|---|---|---|---|---|
| F12 | 7.5% | 8:2 | 0.35% | 2:2 | 0 | 2.5% | 5% PnB:DPnB (1:1) |
| F13 | 7.5% | 75:25 | 0.35% | 2:2 | 0 | 2.5 | 5% PnB:DPnB (1:1) |

Acid Containing PU

| | | | | | | | |
|---|---|---|---|---|---|---|---|
| F14 | 6% | PU-D101 | 0.5% | 2:2 | 0 | 8.5% | 5% PnB:DPnB (1:1) |
| F15 | 6% | PU-D101 | 0.3% | 2:1 | 0 | 8.5% | 5% PnB:DPnB (1:1) |
| F16 | 7.5% | PU-EDA100-14 | 0.3% | 2:2 | 0 | 8.5% | 1.3% PnB:BA(1:1) |
| F17 | 7.5% | PU-EDA100-14 | 0.3% | 2:1 | 0 | 8.5% | 1.3% PnB:BA(1:1) |
| F18 | 7.5% | PU-EDA100-14 | 0.3% | 2:1 | 0 | 8.5% | 2% PnB:DPnB (1:1) |
| F19 | 7.5% | PU-EDA100-14 | 0.4% | 2:2 | 0 | 8.5% | 2% PnB:DPnB (1:1) |
| F20 | 7.5% | PU-EDA125-14 | 0.3% | 2:2 | 0 | 8.5% | 2% PnB:DPnB (1:1) |
| F21 | 7.5% | PU-EDA125-14 | 0.4% | 2:1 | 0 | 8.5% | 2% PnB:DPnB (1:1) |
| F22 | 7.5% | PU-EDA125-14 | 0.5% | 2:2 | 0 | 8.5% | 2% PnB:DPnB (1:1) |
| F23 | 7.5% | PU-BD150-14 | 0.5% | 2:1 | 0 | 8.5% | 2% PnB:DPnB (1:1) |
| F24 | 7.5% | PU-BD150-14 | 0.5% | 2:1 | 0 | 47% IPA | 2% PnB:DPnB (1:1) |
| F25 | 7.5% | PU-BD180-14 | 0.5% | 2:2 | 0 | 47% IPA | 2% PnB:DPnB (1:1) |

For Table 1 above, the “% Organic Polymer” refers to the weight % of the polymer composition (i.e. combined PU-D101:PEAA weight) in the formulation. The “Organic Polymer Ratio of PU-D101:PEAA” refers to the weight ratio of PU-D101 to PEAA. The “% ZnO:BA” refers to the weight % of the combined ZnO:BA weight in the formulation. The “Ratio of Zn:B” refers to the mole ratio of Zinc to Boron.

### Characterisation and Testing

### Coating Thickness

The DFT for a coating was determined using a Fischer Isoscope on aluminium test panels. Painted panels were allowed a 1 hour flash off period before oven curing at 120° F. (49° C.) for a total of 72 hours.

### Paint Stripping

Stripping tests were completed using Bonderite® S-ST1270-6 AERO (Henkel) or CeeBee® E-2787 as the stripping agent. The coupons were taped with aluminized tape (3M Scotch 425) to avoid stripper attacking the interface from the edge. Samples were placed at a stand tilting 25 degree to normal angle, the stripping agent was applied to the coupon using a paint brush and observations were made every 30 minutes. The stripper was removed by a plastic scraper and reapplied every 2 hours.

For stripping times exceeding 12 hours, samples were applied with stripper and laid flat in a container covered with aluminium foil to prevent drying overnight. The samples were put back to the stand and stripping continues the following day for those samples post coating were not fully stripped up to 36 hours. Stripping time (ST) for samples fully stripped were estimated 12≤ST<24.

### SIJA Adhesion Test

Adhesion testing was completed using a Single Impact Jet Apparatus (MIJA Limited, Cambridge, UK). The initial equipment was configured using a 1 mm nozzle and employed 0.22 calibre 5.5 mm Crosman Accupell Pointed Pellets (#11246). The nozzle-specimen distance was fixed at 7 mm. Testing was completed following immersion in water overnight (16<immersion time <24 hours), employing a line laser to locate the impact position and using a 45° specimen to impact droplet geometry. A single water jet was impacted at each site to test adhesion with the pressure employed for the “shot” indicated below its impact. A 600 m/s target velocity was used for each individual shot. The below SIJA mm² values correspond to the amount of surface area removed by the water jet pallet shot. For SIJA adhesion testing, the area removal of an overcoat can be used to determine the degree of intercoat adhesion between overcoat and underlying coating, and this can be quantified by image analysis including visual inspection or measurement, as shown with previous reference to FIG. 2. The reference to “SIJA mm²” in the below examples is a reference to the total surface area of the coating that is removed from the test layer due to the impact of the “shot”.

### Rain Erosion Test

The leading edge of the composite foil for exposure to rain droplets was generated by taping 1.82±0.03 inches with PG-777 tape (3M Co.) from the lower edge of the foil after surface treatment and prior to the topcoat being applied.

Post curing, the foils were soaked in water for 16-24 hours then loaded into a whirling arm chamber and spun at average velocity of 385 miles per hour exposed to simulated rain of 3-4 inches of rainfall per hour and 1-4 mm in droplet size for about 30 mins. Specimens were then removed and analysed.

For rain erosion testing, % area removal of an overcoat can be used to determine the degree of intercoat adhesion between overcoat and underlying coating, and this can be quantified by image analysis including visual inspection or measurement. For example, initially the length of the longest tear is first measured, and then this is converted over to % of area removed. FIG. 2 highlights visual representations relating to a scale of 1 to 10 corresponding to % area of coating removed under rain erosion testing. For example, in FIG. 2 a level 6 scale value is equivalent to about less than 15% area removed, a level 7 is less than about 10%, a level 8 is less than about 5%, and a level 9 is less than about 1%. Depending on various factors including the types of coatings used, the methods of the present disclosure may provide a scale rating of 10, 9, 8, 7, 6, 5, 4, 3, or 2. In one example, the scale rating is at least 7. In another example, the scale rating is at least 10. Depending on the components used in the compositions and processing conditions, in some examples the compositions and coatings of the present disclosure may provide a rain erosion testing value corresponding to the % area removed of less than about 1, 2, 3, 4, 5, 6, 7, 8, 9, 10, 15, 20, 25, 30, 40, 50, 60, 70, 80, or 90%. It will be appreciated that the more overcoat removed corresponds to inferior inter-coat adhesion.

The adhesive linkage between the existing organic coating and the substrate (or layer there between), or adhesive linkage between the existing organic coating and the further coating, may also be determined by other methods such as a wet and dry cross-hatch scribe test, particularly for applications outside aerospace coatings. Dry adhesion of the coatings may be determined according to ASTM D3359, Standard Test Methods for Measuring Adhesion by Tape Test, Test method B. A crosshatch pattern can be scribed through each coating composition down to the substrate. A strip of 1 inch wide masking tape, such as 3M type 250, can then be applied. The tape can be pressed down using two passes of a 4.5-pound rubber covered roller. The tape can then be removed in one abrupt motion perpendicular to the panel. The adhesion can then be rated by a visual examination of the paint at the crosshatch area to determine % area of removal of the coating as described above.

### Example 1

The solubility of ZnO in aqueous ammonia solution was assessed in the presence or absence of increasing amounts of boric acid (BA). It was found that the addition of boric acid to a formulation containing ZnO and aqueous ammonia improves the solubility of ZnO in the ammonia solution. This has the advantage of reducing the amount of ammonia required, as shown in Table 2. Theoretic ratio of ammonia to ZnO and BA is calculated by assuming that 4 moles of ammonia is required to form 1 mol Zn(NH₃)₄O₂⁺⁺ complex and that 3 moles of ammonia is required to form ammonium borate salt.

TABLE 2
Solubility of ZnO in ammonia water solution
with boron co-complexing agent.

| | ZnO | Zn:B 1:2 | Zn:B2:3 | Zn:B1:1 |
|---|---|---|---|---|
| Solubility conc. | Low, <1% | High, >10% | High, ~10% | High, >5% |
| % (wt) | | | | |
| NH₃:ZnO molar | 60:1 | 12:1 | 9.2:1 | 16:1 |
| ratio | | | | |
| Theoretical molar | 4:1 | 10:1 | 8.5:1 | 7:1 |
| ratio from | | | | |
| Zn(NH₃)₄O₂⁺⁺ | | | | |

In the above Table 2, the “solubility concentration” refers to the weight % of ZnO in the ammonia solution before reaching saturation with solid particles of ZnO.

### Example 2

The rheological properties of conventional intermediate coatings are sensitive to variations in temperature and humidity which can impact application at temperatures higher than 80° F. Accordingly, there is a need for the selectively strippable coating to have a broad application window.

The coating compositions F1 to F5 (Table 3) were prepared as described above.

TABLE 3
Coating compositions

| | F1 | F2 | F3 | F4 | F5 |
|---|---|---|---|---|---|
| PU-D101:P5990I | 7.5 | 8.5 | 10 | 10 | 10 |
| (4:1) % (wt) | | | | | |
| ZnO-BA % (wt) | 0.35 | 0.35 | 0.35 | 0.3 | 0.35 |
| Zn:B mole ratio | 2:3 | 2:3 | 2:3 | 2:2 | 2:2 |
| Water % (wt) | 47.2 | 46.2 | 44.7 | 44.7 | 44.7 |
| IPA % (wt) | 40 | 40 | 40 | 40 | 40 |
| Additive % (wt)* | 5 | 5 | 5 | 5 | 5 |

*Additive: 1:1 (by weight) benzyl alcohol and propylene glycol propyl ether (PnP)

For Table 3 above, the “PU-D101:P5990I (4:1) % (wt)” refers to the weight % in the formulation of the combined polymer constituents (i.e. total combined weight of PU-D101 and P5990I, which is provided as a weight ratio of 4:1 respectively). The “Ratio of PU-D101:P5990I” refers to the weight ratio of PU-D101 to P5990I. The reference to “% (wt)” refers to the weight % of the component in the coating formulation.

Al coupons were treated as above and primed with CA7501 then coated with one of the formulations described in Table 3 at a thickness of 2 microns. The temperature and humidity was maintained at the values indicated in Table 3 during application of both the primer and selectively strippable coating. The panels were left to dry for 2 hours before a polyurethane top coat (Desothane® CA8000 white) was applied. The top coat was allowed to cure for 72 hours/at 120° F. Thin and even coating films were achieved for all conditions tested. Stripper Bonderite® S-ST1270-6 AERO was used. The coating systems were tested for strippability and adhesion. The results of the tests are shown in Table 4.

TABLE 4
Performance of test coating compositions under application conditions

| Application | | | | | | |
|---|---|---|---|---|---|---|
| conditions* | | F1 | F2 | F3 | F4 | F5 |
| 65° F. | SIJA (mm²) | 1.8 ± 0.9 | 2.0 ± 1.5 | 3.7 ± 1.4 | 3.3 ± 0.6 | 2.1 ± 0.5 |
| 75% RH | Stripping (hours) | <5 | <5 | <6 | 6 | <6 |
| 95° F. | SIJA (mm²) | 2.6 ± 0.3 | 2.3 ± 1.1 | 2.5 ± 0.6 | 2.6 ± 0.7 | 2.7 ± 0.5 |
| 75% RH | Stripping (hours) | 3 | 3.5 | 4 | 3.5 | 3.5 |
| 65° F. | SIJA (mm²) | 4.3 ± 0.7 | 3.7 ± 1.2 | 10.4 ± 2.9 | 9.8 ± 3.1 | 3.3 ± 2.1 |
| 18% RH | Stripping (hours) | 4 | 5.5 | 4 | 4 | 4 |
| 95° F. | SIJA (mm²) | 3.1 ± 0.7 | 2.5 ± 0.5 | 3.4 ± 1.4 | 2.7 ± 0.5 | 2.6 ± 0.6 |
| 18% RH | Stripping (hours) | 5.5 | 5.5 | 5.5 | 5.5 | 5.5 |

*Note:
The temperature and humidity was maintained at these values during application of both the primer and selectively strippable coating.

In Table 4 above, reference to “SIJA (mm²)” refers to the area of removal of the selectively strippable coating from the coated substrate using the SIJA testing method as described above.

Excellent intercoat adhesion and stripping performance were obtained for test coatings F1-F5 for temperatures ranging from 65° F. to 95° F. and relative humidity (RH) ranging from 18% to 75%. Conventional intermediate coating technology may have an application window in the range of 65° F. to 80° F., 30% to 60% RH for application and a cure window of 65° F. to 85° F., 30% to 60% RH. The selectively strippable coatings exemplified herein can provide a broader application and cure window compared to conventional intermediate coatings.

### Example 3

Current intermediate coating technology requires a coating thickness of 5 to 10 microns. There is also a need for coatings that offer good strippability and intercoat adhesion at coating thicknesses less than 5 microns.

The formulations described in Table 2 were applied to primer-coated Al coupons at varying thicknesses and top coat Desothane® CA8000 white was applied as in Example 2. The strippability (Stripper Bonderite® S-ST1270-6 AERO) and adhesion of the coatings were tested. The results of the tests are shown in Table 5. The dry film thickness (DFT) for F1 and F2 were calculated based on a “Thickness-Number of Spray Passes” correlation established with Formulation 3 and corrected with a concentration factor (×0.75 for F1 and ×0.85 for F2). The DFT of F4 and F5 were calculated based on F3, which was the same polymer concentration.

TABLE 5
Performance of test coating compositions
as function of dried film thickness

| | F1 | F2 | F3 | F4 | F5 |
|---|---|---|---|---|---|
| DFT (μm) | 1.6 | 1.8 | 2.1 ± 0.6 | | |
| Stripping | 3 | 3.5 | 4 | 3.5 | 3.5 |
| (hours) | | | | | |
| SIJA (mm²) | 3.0 ± 0.2 | 3.1 ± 0.6 | 4.1 ± 0.8 | 3.7 ± 1.0 | 3.2 ± 0.4 |
| DFT (μm) | 3.2 | 3.6 | 4.6 ± 0.5 | | |
| Stripping | 3.5 | 4 | 4 | 3.5 | 3.5 |
| (hours) | | | | | |
| SIJA (mm²) | 2.7 ± 0.7 | 3.2 ± 0.6 | 4.2 ± 1.1 | 2.4 ± 0.4 | 2.4 ± 0.4 |
| DFT (μm) | 6.4 | 7.2 | 9.7 ± 0.9 | | |
| Stripping | 5.5 | 5.5 | 8.5 | 7 | 7 |
| (hours) | | | | | |
| SIJA (mm²) | 2.6 ± 0.2 | 2.7 ± 0.8 | 1.9 ± 0.6 | 3.3 ± 1.2 | 4.2 ± 0.8 |

Excellent intercoat adhesion and selective strippability were obtained for a DFT from less than 2 microns to around 10 microns in initial trials. Accordingly, the strippable coatings of at least some examples of the present disclosure have the potential to reduce the contribution to the coating weight from the selectively strippable layer compared to conventional intermediate coatings (Manufacturer specification 8 to 12 micrometers), for example by at least about 10%, 20%, or 30%, and in some cases up to about 80%.

### Example 4

In this example, Aerodur® basecoat/clear coat was used as an overcoat. Treatment of Al coupons and coatings assembly were as described in Example 2. The formulations contain 7.5% (wt) of PU-D101-PEAA and the ratio of PU-D101:PEAA was varied (Table 6). The curing conditions for both the primer CA7501 and the coating formulations were 2 hours at 35° C. and 18% RH in a humidity chamber. The coating systems were tested for strippability (Stripper Bonderite® S-ST1270-6 AERO) and adhesion and the results of the tests are shown in Table 7.

TABLE 6
Test Coating Compositions

| | F6 | F7 | F8 | F9 | F10 | F11 |
|---|---|---|---|---|---|---|
| PU-D101:P5990I | 80:20 | 85:15 | 90:10 | 80:20 | 80:20 | 80:20 |
| ZnO-BA (% wt) | 0.35% | 0.30% | 0.25% | 0.35% | 0.35% | 0.35% |
| Zn:B | 1:1 | 1:1 | 1:1 | 4:3 | 6:5 | 5:6 |
| Water | 55.2% | 55.2% | 55.3% | 55.2% | 55.2% | 55.2% |
| IPA (% wt) | 30% | 30% | 30% | 30% | 30% | 30% |
| Additive (% wt)* | 7% | 7% | 7% | 7% | 7% | 7% |

*Additive is a mixture of PnP/PnB/PPh (5:4:5 by weight).

TABLE 7
Performance of test coating compositions
under application conditions

| | | SIJA | Stripping |
|---|---|---|---|
| Formulation | | (mm²) | (hours) |
| No Treatment | | 3.5 ± 1.6 | >36 hr |
| F6 | 7.5% PU-D101-P5990I (8:2), | 1.2 ± 0.4 | 8 |
| | 0.33% Zn—B (2:2) | | |
| F7 | 7.5% PU-D101-P5990I (85:15), | 1.2 ± 0.4 | 7.5 |
| | 0.3% Zn—B (2:2) | | |
| F8 | 7.5% PU-D101-P5990I (90:10), | 1.2 ± 0.4 | 9 |
| | 0.25% Zn—B (2:2) | | |
| F9 | 7.5% PU-D101-P5990I (8:2), | 1.4 ± 0.4 | 9 |
| | 0.33% Zn—B (4:3) | | |
| F10 | 7.5% PU-D101-P5990I (8:2), | 1.4 ± 0.4 | 7.5 |
| | 0.35% Zn—B (6:5) | | |
| F11 | 7.5% PU-D101-P5990I (8:2), | 2.1 ± 0.4 | 8 |
| | 0.35% Zn—B (5:6) | | |

As can be seen in Table 7, excellent intercoat adhesions were obtained for this coating assembly comprising a basecoat/clearcoat polyurethane over coat. Stripping time was slightly longer compared to the Desothane® overcoat system but is still very good.

### Example 5

In this example, the coupons were prepared as described in Example 4, however the over coat consisted of three layers of polyurethane coatings (Desothane® topcoat (25 μm), Aerodur® basecoat/clearcoat (75 μm)). Desothane® topcoat was cured overnight under ambient conditions and activated with AP-1 before the Aerodur® basecoat/clear coat was applied. The coating systems were tested for strippability (Stripper Bonderite® S-ST1270-6 AERO) and adhesion and the results of the tests are shown in Table 8.

TABLE 8
Performance of test coating compositions
under application conditions

| | | SIJA | Stripping |
|---|---|---|---|
| Formulation | | (mm²) | (hours) |
| F6 | 7.5% PU-D101-P5990I (8:2), | 9.0 ± 4.4 | 9 |
| | 0.33% ZnO-BA (2:2) | | |
| F7 | 7.5% PU-D101-P5990I (85:15), | 3.8 ± 2.0 | 9 |
| | 0.3% ZnO-BA (2:2) | | |
| F8 | 7.5% PU-D101-P5990I (90:10), | 4.0 ± 1.1 | 9 |
| | 0.25% ZnO-BA (2:2) | | |
| F9 | 7.5% PU-D101-P5990I (8:2), | 3.9 ± 0.7 | 9 |
| | 0.33% ZnO-BA (4:3) | | |
| F10 | 7.5% PU-D101-P5990I (8:2), | 7.3 ± 1.9 | 10 |
| | 0.35% ZnO-BA (6:5) | | |
| F11 | 7.5% PU-D101-P5990I (8:2), | 3.7 ± 2.3 | 10 |
| | 0.35% ZnO-BA (5:6) | | |

It was shown that good intercoat adhesion and strippability of post coatings were obtained for over coatings consisting of Desothane monocoat and Aerodur basecoat/clearcoat.

### Example 6

In this example, coating stack up was prepared as given in Example 5. Both samples of Al foils for rain erosion and flat panel for SIJA and stripping were primed and cured 2 hours at ambient (22° C. and 40%) RH. Selectively strippable coatings F6 to F8 were used as described in Table 8 and applied 2 hours after primer, dried at ambient for 2 hours before Desothane® white was applied. Aerodur® basecoat/clearcoat was applied in the following day and cured at 49° C. for 72 hours. Stripping was carried out on flat panel using CeeBee® E2787 alkaline stripper. Results of the test including SIJA adhesion, rain erosion and stripping are shown in Table 9.

TABLE 9
Rain erosion testing

| | | | Rain | |
|---|---|---|---|---|
| | | SIJA | Erosion | Stripping |
| Formulation and Treatment | | (mm²) | Scale | (hours) |
| No Treatment | | 3.5 ± 1.6 | 9, 9, 8 | >36 |
| F6 | 7.5% PU-D101-P5990I (8:2), | 3.2 ± 1.6 | 9, 8, 8 | 10 |
| | 0.33% Zn—B (2:2) | | | |
| F7 | 7.5% PU-D101-P5990I (85:15), | 2.3 ± 2.1 | 8, 9, 9 | 10 |
| | 0.3% Zn—B (2:2) | | | |
| F8 | 7.5% PU-D101-P5990I (90:10), | 2.4 ± 1.6 | 9, 8, 9 | 10 |
| | 0.25% Zn—B (2:2) | | | |

It was shown that good SIJA adhesion (failure area less than 5 mm²) was obtained for all samples including untreated bench mark. Rain erosion has rating better than 8, showing excellent intercoat adhesion and in good agreement with the SIJA test. Overcoat of samples applied with selectively strippable coatings F6 to F8 were completely stripped off within 10 hours while no sign of coating stripping was observed for untreated bench mark sample.

### Example 7

In this example, coating stack up was prepared as given in Example 4. Al panel for SIJA and stripping were primed and cured 3 hours at 18° C. and 75% RH in an environmental chamber. Compositions of the treatment formulations were given in Table 10. F12 and F13 were applied 2 hours after primer and cured 2 hours under same conditions. SIJA adhesion and stripping (CeeBee® E2787) are shown in Table 10.

TABLE 10
Formulations prepared from PU-D101 and PEAA P5980
and performance of SIJA adhesion and stripping

| | | ZnO/BA | | SIJA | Stripping |
|---|---|---|---|---|---|
| Code | Formulation | % | Zn:B | (mm²) | (hours) |
| F12 | 7.5% PU-D101:P5980 | 0.35 | 2:2 | 4.5 ± 0.7 | 9.5 |
| | (80:20) | | | | |
| F13 | 7.5% PU-D101:P5980 | 0.35 | 2:2 | 4.2 ± 0.6 | 9.5 |
| | (75:25) | | | | |

This example showed that that when PEAA was replaced with higher molecular weight PEAA P5980, good inter-coat adhesion and strippability were obtained.

### Example 8

In this example, coating stack up was prepared as given in Example 5. Selectively stripping coating formulations F14 and F15 were prepared from commercial PU-D101 dispersion and formulations were given in Table 11. Primer CA7501 was cured for 3 hours and then the coating composition for 2 hours at ambient. Results of SIJA adhesion and stripping (CeeBee® E2787) are shown in Table 11.

TABLE 11
Formulations prepared from D101 and performance
of SIJA adhesion and stripping

| | | | | SIJA | Stripping |
|---|---|---|---|---|---|
| Code | PU | ZnO/BA % | Zn:B | (mm²) | (hours) |
| F14 | 6%PU-D101 | 0.5 | 2:1 | 4.7 ± 0.5 | 6.5 |
| F15 | 6% PU-D101 | 0.3 | 3:2 | 5.0 ± 0.8 | 6.5 |

It can be noted from the results that the selectively strippable coating prepared from acid containing polyurethane (PU-D101 Mw 54900, containing about 5% acid calculated from the neutral amine disclosed) provided good inter-coat adhesion and strippability.

### Example 9

Polyurethane containing acid functionality (DMBA) and the dispersions made as described herein were given in Table 12.

TABLE 12
Formulations of acid containing PU
dispersion and molecular weight

| | Acid | | | |
|---|---|---|---|---|
| | wt | Chain | | |
| PU Code | % | extender | Solvents | Mw |
| EDA100 | 10 | EDA | 14% MEK, 10% IPA, 24% | 12900 |
| | | | PnP and water | |
| EDA125 | 12.5 | EDA | 14% MEK, 10% IPA, 24% | 13700 |
| | | | PnP and water | |
| BD150 | 15 | BD | 18% MEK, 25% IPA, and water | 19900 |
| BD180 | 18 | BD | 18% MEK, 25% IPA, and water | 35500 |

Low acid content containing polyurethane are normally made for commercial PU dispersion. The examples above show that high acid containing PU can be prepared with high molecular weight, for example greater than about 10,000 Mw.

### Example 10

In this example, coating stack up was prepared as given in Example 4. Coating formulations containing 7.5 wt % of PU were described in Table 13. The curing conditions for both the primer CA7501 and coating formulations were 2 hours at 35° C. oven. The coating systems were tested for strippability (CeeBee® E2787) and adhesion and the results of the tests are shown in Table 13.

TABLE 13
Formulations with acid containing PU and performance
of SIJA adhesion and stripping

| | | | | SIJA | Stripping |
|---|---|---|---|---|---|
| Code | PU | ZnO/BA % | Zn:B | (mm²) | (hours) |
| F16 | 7.5% EDA100 | 0.3 | 2:2 | 2.3 ± 1.4 | 4 |
| F17 | 7.5% EDA100 | 0.3 | 2:1 | 3.0 ± 0.4 | 4 |

This example demonstrated that coating formulations prepared with high acid containing PU also provide good inter-coat adhesion and strippability. Curing at high temperature and low humidity has no detrimental impact on the adhesion and strippability performance.

### Example 11

In this example aluminium coupons were treated and primed with CA7501 as described in Example 2. Desothane monocoat was applied over the selectively strippable coating, and cured overnight at ambient conditions. Surface activator AP-1 was applied to the Desothane prior to Aerudur basecoat/cleacoat application. The multi-layered coatings were 25 μm primer CA7501/coating formulation/25 μm Aerodur Basecoat/25 Desothane white/50 μm Aerodur basecoat/40 μm. Coating formulations were prepared from PU-EDA100 and PU-EDA125 and specified in Table 14. Both the primer CA7501 and coating formulation were cured for 2 hours at 35° C. and 75% RH in a humidity chamber. SIJA adhesion and stripping (CeeBee® E2787) performance are shown in Table 14.

TABLE 14
Formulation performance in multi-layered coating systems
combining PU monocoat and basecoat/clear coat.

| | | | | SIJA | Stripping |
|---|---|---|---|---|---|
| Code | PU | ZnO/BA % | Zn:B | (mm²) | (hours) |
| F29 | 7.5% PU-EDA100 | 0.3 | 2:1 | 4.2 ± 1.3 | 7 |
| F30 | 7.5% PU-EDA100 | 0.4 | 2:2 | 6.4 ± 4.1 | 7 |
| F31 | 7.5% PU-EDA125 | 0.3 | 2:2 | 4.9 ± 1.3 | 5.5 |
| F32 | 7.5% PU-EDA125 | 0.4 | 2:1 | 4.1 ± 1.1 | 5.5 |
| F33 | 7.5% PU-EDA125 | 0.5 | 2:2 | 4.1 ± 0.8 | 5.5 |

This example demonstrated that coatings prepared with high acid containing PU also gives good inter-coat adhesion and strippability. These examples use a different overcoat stacking layer (monocoat followed by basecoat/clearcoat coating system). Curing at high temperature and high humidity has no significant impact on the adhesion and strippability performance.

### Example 12

In this example, coating stack up was prepared as given in Example 4. Curing conditions for primer and formulations were specified in Table-15. Selectively strippable coatings were prepared from PU-BD dispersion formulations described above and provided in Table 15 along with adhesion and stripping (CeeBee® E2787) results.

TABLE 15
Formulations with acid containing PU and performance
of SIJA adhesion and stripping

| | F34: 7.5% PU-BD150, | | F35: 7.5% PU-BD, | | F36: 7.5% PU-BD180, | |
|---|---|---|---|---|---|---|
| | 0.5% ZnO/BA, | | 0.5% ZnO/BA, | | 0.5% ZnO/BA, | |
| | Zn:B = 2:1 | | Zn:B = 2:1 | | Zn:B = 2:2 | |
| Curing | SIJA | Stripping | SIJA | Stripping | SIJA | Stripping |
| Conditions | (mm²) | (hours) | (mm²) | (hours) | (mm²) | (hours) |
| 18° C. and | 2.8 ± 1.1 | 4.0 | 3.3 ± 0.4 | 4.0 | 2.9 ± 0.2 | 4.0 |
| 18% RH | | | | | | |
| 18° C. and | 2.4 ± 0.9 | 4.5 | 3.7 ± 0.3 | 4.5 | 2.9 ± 0.8 | 4.5 |
| 75% RH | | | | | | |
| 35° C. and | 3.0 ± 0.6 | 4.5 | 2.8 ± 1.3 | 4.5 | 3.1 ± 0.3 | 5.5 |
| 75% RH | | | | | | |
| 35° C. and | 3.1 ± 0.3 | 4.0 | 2.1 ± 0.1 | 4.0 | 2.7 ± 0.5 | 4.0 |
| 75% RH | | | | | | |

Solvent for formulation F34-F36: 47% IPA, 1% PnB, 1% DPnB and water

This examples demonstrated that formulations and coatings prepared with high acid containing PU-BD according to the invention gives good inter-coat adhesion and strippability. The coatings have wide operation windows for temperature varying from 18° C. to 35° C. and humidity from 18% RH to 75% RH.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

All publications discussed and/or referenced herein are incorporated herein in their entirety.

Any discussion of documents, acts, materials, devices, articles or the like which has been included in the present specification is solely for the purpose of providing a context for the present disclosure. It is not to be taken as an admission that any or all of these matters form part of the prior art base or were common general knowledge in the field relevant to the present disclosure as it existed before the priority date of each claim of this application.

1. A selectively strippable coating, the selectively strippable coating comprising:
(a) one or more organic polymers comprising carboxylic acid functionalities;
(b) a metallic agent; and
(c) a boron agent.

2. (canceled)

3. The selectively strippable coating according to claim 1, wherein the one or more organic polymers comprising carboxylic acid functionalities of (a) is provided by an organic film former comprising or consisting of one or more organic polymers comprising carboxylic acid functionalities.

4. The selectively strippable coating according to claim 1, wherein the metallic agent (b) and boron agent (c) is provided by a metal-boron complex or salt.

5. The selectively strippable coating according to claim 1, wherein the one or more organic polymer comprising carboxylic acid functionalities has a number average molecular weight of at least about 5000 or between about 5000 and 100000.

6. The selectively strippable coating according to claim 1, wherein the carboxylic acid functionalities of each organic polymer is provided in an amount of between about 1 to 30 wt % of the organic polymer.

7. (canceled)

8. The selectively strippable coating according to claim 1, wherein the molar ratio (M:A) of the metallic agent (M) to the carboxylic acid functionality (A) of the organic polymer is provided between about 10:1 (M:A) to 1:10 (M:A).

9-24. (canceled)

25. A primer coated substrate comprising the selectively strippable coating according to claim 1 disposed thereon.

26. A coated substrate comprising the selectively strippable coating according to claim 1 disposed thereon, wherein the coated substrate is selected from the group consisting of a composite, metal, polymer, and elastomer, each of which is previously coated.

27. (canceled)

28. A coating system which comprises:
(i) a coated substrate;
(ii) at least one post coating layer; and
(iii) the selectively strippable coating according to claim 1 located between (i) and (ii).

29. A selectively strippable coating composition comprising:
a) an organic polymer comprising carboxylic acid functionalities;
b) a metallic agent;
c) a boron agent; and
d) a solvent.

30. (canceled)

31. The selectively strippable coating composition according to claim 29, wherein the composition has a solid concentration of about 0.1% to 40% based on the total weight of the composition.

32. (canceled)

33. The selectively strippable coating composition according to claim 29, wherein the organic film former or the organic polymer(s) comprising carboxylic acid functionalities is provided in the coating composition in an amount of about 1 to 20 wt % based on the weight of the total composition.

34. (canceled)

35. The selectively strippable coating composition according to claim 29, wherein the one or more organic polymers comprising carboxylic acid functionalities of (a) is provided by an organic film former comprising or consisting of one or more organic polymers comprising acid functionalities.

36. The selectively strippable coating composition according to claim 29, wherein the metallic agent (b) and boron agent (c) is provided by a metal-boron complex or salt.

37. The selectively strippable coating composition according to claim 29, wherein the one or more organic polymer comprising carboxylic acid functionalities has a number average molecular weight of at least about 5000 or between about 5000 and 100000.

38. The selectively strippable coating composition according to claim 29, wherein the carboxylic acid functionalities of each organic polymer is provided in an amount of between about 1 to 30 wt % of the organic polymer.

39. (canceled)

40. The selectively strippable coating composition according to claim 29, wherein the molar ratio (M:A) of the metallic agent (M) to the carboxylic acid functionality (A) of the organic polymer is provided between about 10:1 (M:A) to 1:10 (M:A).

41-43. (canceled)

44. The selectively strippable coating composition according to claim 29, wherein the composition is a water based coating formulation comprising an aqueous solvent.

45. The selectively strippable coating composition according to claim 29, wherein the composition further comprises an alcohol in an amount of about 1 to about 40 wt % based on the composition.

46-58. (canceled)

59. The selectively strippable coating composition according to claim 29, further comprising a wetting agent in an amount of about 0.01 to 15 wt %.

60-61. (canceled)

62. A process for preparing a coating system, comprising:
applying to a coated substrate the selectively strippable coating composition according to claim 29; and
applying a post coating layer to the selectively strippable coating applied to the coated substrate.

63-65. (canceled)

66. The process according to claim 62 comprising:
applying the selectively strippable coating composition to the coated substrate within a first predetermined time, temperature and humidity; and
applying at least one post coating layer to the selectively strippable coating present on the coated substrate within a second predetermined time, temperature and humidity.

67. The process according to claim 66, wherein for the first and second predetermined humidity and temperature, the relative humidity in the process environment is between about 10% and 70% and the temperature range is between about 15° C. and 30° C.

68. (canceled)

69. A process for selectively removing at least one post coating layer from the coating system according to claim 28 comprising:
a) treating the at least one post coating layer with an alkaline stripping agent capable of disrupting the selectively strippable coating; and
b) removing the at least one post coating layer from the coated substrate.

70-73. (canceled)

74. The process according to claim 69, wherein the alkaline stripping agent is provided in an aqueous alkaline liquid formulation comprising the alkaline stripping agent, one or more solvents, and one or more optional additives.

75. The process according to claim 69 further comprising:
applying a mechanical process for facilitating the removal of the post coating layer(s);
c) optionally cleaning the surface of the coated substrate; and
d) optionally applying a selectively strippable coating composition and any post-coating layers.
